(19) United States
(12) Patent Application Publication
(10) Pub. No.: US 2019/0128483 A1
(43) Pub. Date: May 2, 2019

(54) LED TUBE LAMP

(71) Applicant: JIAXING SUPER LIGHTING ELECTRIC APPLIANCE CO.,LTD, Jiaxing City (CN)

(72) Inventors: HONG XU, Jiaxing City (CN); CHANG YANG, Jiaxing City (CN); SHAULIANG CHEN, Zhubei City (TW); WENJANG JIANG, Jiaxing City (CN); WENTAO YAO, Jiaxing City (CN)

(21) Appl. No.: 16/228,815

(22) Filed: Dec. 21, 2018

Related U.S. Application Data
(63) Continuation of application No. 15/339,740, filed on Oct. 31, 2016, now Pat. No. 10,161,569.
Application No. 15/339,740 is a continuation-in-part of application No. PCT/CN2015/096501, filed on Dec. 5, 2015.

(30) Foreign Application Priority Data
Sep. 2, 2015 (CN) 201510555543.4
Oct. 29, 2015 (CN) 201510724263.1
Oct. 30, 2015 (CN) 201510726484.2
Dec. 4, 2015 (CN) 201510882517.2
Jan. 26, 2016 (CN) 201610050944.9
Aug. 11, 2016 (CN) 201610658402.X

(51) Int. Cl. F21K 9/275; F21V 29/76; F21V 5/04; F21V 29/89

(52) U.S. Cl. CPC F21K 9/275; F21V 29/767; F21Y 2115/10; F21V 5/04; F21V 29/89; F21V 5/043

(57) ABSTRACT

An LED tube lamp, comprising: a lamp tube, which includes a light transmissive portion, a reinforcing portion and an end cap; and an LED light assembly, which includes an LED light source and an LED light strip. The light transmissive portion is fixedly connected to the reinforcing portion. The reinforcing portion includes a plurality of bracing structures at endpoints. The bracing structure includes a combination of a vertical rib and a horizontal rib. The LED light strip abuts against the bracing structure, which holds the LED light assembly in place. The LED light source is thermally and electrically connected to the LED light strip. The end cap is attached to an end of the lamp tube. A cross section of the lamp tube defines a hypothetical non-circle curve of constant width.

### RELATED APPLICATIONS

This is a continuation-in-part application of U.S. Ser. No. 15/339,740 filed Oct. 31, 2016, which is a continuation-in-part application of International Application PCT/CN2015/096501, with an international filing date of Dec. 5, 2015, which in turn claims the benefit of the following Chinese Patent Applications: CN201510555543.4 filed Sep. 2, 2015; CN 201510724263.1 filed Oct. 29, 2015; CN201510726484.2 filed Oct. 30, 2015; CN201510882517.2 filed Dec. 4, 2015; CN201610050944.9 filed Jan. 26, 2016; and CN201610658402.X filed Aug. 11, 2016, each of which is incorporated herein by reference in its entirety.

If (1) a term in the present application conflicts with the term used in a previous application to which the present application claims priority, or (2) conflicts with a term in an application incorporated by reference (2a) into the present application or into (2b) an application to which the present application claims priority, a construction based on the term as used or defined in the present application prevails.

### FIELD OF THE INVENTION

The present invention relates to features of LED luminaries. More particularly, this invention describes various new and useful improvements for LED tube lamps.

### BACKGROUND OF THE INVENTION

LED lighting technology is rapidly developing to replace traditional incandescent and fluorescent lightings. LED tube lamps are mercury-free in comparison with fluorescent tube lamps that need to be filled with inert gas and mercury. Thus, it is not surprising that LED tube lamps are becoming a highly desirable illumination option among different available lighting systems used in homes and workplaces, which used to be dominated by traditional lighting options such as compact fluorescent light bulbs (CFLs) and fluorescent tube lamps. Benefits of LED tube lamps include improved durability and longevity and far less energy consumption; therefore, when taking into account all factors, they would typically be considered as a cost-effective lighting option.

Typical LED tube lamps have a variety of LED elements and driving circuits. The LED elements include LED chip-packaging elements, light diffusion elements, high efficient heat dissipating elements, light reflective boards and light diffusing boards. Heat generated by the LED elements and the driving elements is considerable and mainly dominates the illumination intensity such that the heat dissipation needs to be properly disposed to avoid rapid decrease of the luminance and the lifetime of the LED lamps. Problems including power loss, rapid light decay, and short lifetime due to poor heat dissipation are always the key factors in consideration of improving the performance of the LED illuminating system. It is therefore one of the important issues to solve the heat dissipation problem of the LED products.

Nowadays, most of the LED tube lamps use plastic tubes and metallic elements to dissipate heat from the LEDs. The metallic elements are usually exposed to the outside of the plastic tubes. This design improves heat dissipation but heightens the risk of electric shocks. The metallic elements may be disposed inside the plastic tubes. However, heat remains inside the plastic tubes and deforms the plastic tubes. Deformation of the plastic tubes also occurs even when the elements to dissipate heat from the LEDs are not metallic.

The metallic elements disposed to dissipate heat from the LEDs may be made of aluminum. However, aluminum is too soft to sufficiently support the plastic tubes when the deformation of plastic tubes occurs due to the heat as far as the metallic elements disposed inside the plastic tubes are concerned.

As a result, the current related skills still could not be applied to deal with the above-mentioned worse heat conduction, poor heat dissipation, heat deformation, and electric shock defects. On the other hand, the LED tube lamp may be provided with power via two ends of the lamp and a user is easily to be electric shocked when one end of the lamp is already inserted into a terminal of a power supply while the other end is held by the user to reach the other terminal of the power supply.

In view of above-mentioned issues, the claimed invention and the preferred embodiments are proposed below.

### OBJECT AND SUMMARY OF THE INVENTION

Therefore, it is an object of the claimed invention to provide an improved LED tube lamp having a redesigned lamp tube. In some embodiments, the cross section of the lamp tube has an irregular shape. In other embodiments, the cross section of the lamp tube defines a polygon, e.g. a triangle. The lamp tube will stay put on a desk even with an inclined plane. In some embodiments, the cross section of the lamp tube defines a triangle having edges curved outwards. In other embodiments, vertices of the triangle defined by the cross section of the lamp tube are filleted.

In accordance with an exemplary embodiment of the present invention, the LED tube lamp comprises: a lamp tube, which includes a light transmissive portion, a reinforcing portion and an end cap; and an LED light assembly, which includes an LED light source and an LED light strip. The light transmissive portion is fixedly connected to the reinforcing portion. The reinforcing portion includes a plurality of bracing structures at endpoints. The bracing structure includes a combination of a vertical rib and a horizontal rib. The LED light strip abuts against the bracing structure, which holds the LED light assembly in place. The LED light source is thermally and electrically connected to the LED light strip. The end cap is attached to an end of the lamp tube. A cross section of the lamp tube defines a hypothetical non-circle curve of constant width.

In an embodiment, the cross section of the lamp tube defines a first hypothetical Reuleaux triangle.

In an embodiment, vertices on the first hypothetical Reuleaux triangle define a hypothetical isosceles triangle.

In an embodiment, a fillet is configured on a vertex on the cross section of the lamp tube.

In an embodiment, a fillet is configured on all vertices on the cross section of the lamp tube.

In an embodiment, the fillet is configured on an interior corner of the vertex on the cross section of the lamp tube.

In an embodiment, a fillet is configured on an exterior corner of the vertex on the cross section of the lamp tube.

In an embodiment, a first fillet is configured on an interior corner of the vertex on the cross section of the lamp tube. A second fillet is configured on an exterior corner of the vertex opposite the interior corner of the vertex on the cross section of the lamp tube. The first fillet and the second fillet are spaced apart by a fixed normal distance.

In an embodiment, the fixed normal distance equals a thickness of the lamp tube adjacent to the filleted corner.

In an embodiment, a cross section of the end cap defines a second hypothetical Reuleaux triangle.

In an embodiment, the first hypothetical Reuleaux triangle and the second hypothetical Reuleaux triangle are parallel curves. The second hypothetical Reuleaux triangle encompasses the first hypothetical Reuleaux triangle.

In an embodiment, a fillet is configured on a vertex on the cross section of the end cap.

In an embodiment, a fillet is configured on all vertices of the cross section of the end cap.

In an embodiment, a fillet is configured on an interior corner of the vertex on the cross section of the end cap.

In an embodiment, a fillet is configured on an exterior corner of the vertex on the cross section of the end cap.

In an embodiment, a bottom edge of a cross section of the reinforcing portion defines a first circular arc on the first hypothetical Reuleaux triangle.

In an embodiment, the bottom edge of the cross section of the reinforcing portion defines a first portion of the first circular arc on the first hypothetical Reuleaux triangle.

In an embodiment, the first portion of the first circular arc on the first hypothetical Reuleaux triangle is a middle portion on the first circular arc on the first hypothetical Reuleaux triangle.

In an embodiment, a cross section of the light transmissive portion defines: a right portion of the first circular arc on the first hypothetical Reuleaux triangle. A left portion of the first circular arc on the first hypothetical Reuleaux triangle. A second circular arc on the first hypothetical Reuleaux triangle; and a third circular arc on the first hypothetical Reuleaux triangle.

In an embodiment, a left vertical rib having a first left base extends upwards from a point S₁ at which the light transmissive portion and the reinforcing portion merge; a left horizontal rib merges with the left vertical rib at a point slightly higher than an upper surface of the LED light strip. A right vertical rib having a first right base extends at a point S₂ at which the light transmissive portion and the reinforcing portion merge. A right horizontal rib merges with the right vertical rib at a point slightly higher than the upper surface of the LED light strip; and a distance between the first left base and the first right base is slightly greater than a width of the LED light strip.

In an embodiment, the left vertical rib leans slightly inwards towards a left edge of the LED light strip. The right vertical rib leans slightly inwards towards a right edge of the LED light strip.

In an embodiment, the left horizontal rib angles slightly downwards towards the upper surface of the LED light strip. The right horizontal rib angles slightly downwards towards the upper surface of the LED light strip.

In an embodiment, a left protruding part having a second left base erects from a point closer to S₁ than S₂ between S₁ and S₂ on the reinforcing portion towards a lower surface of the LED light strip. A right protruding part having a second right base erects from a point closer to S₂ than S₁ between S₁ and S₂ on the reinforcing portion towards the lower surface of the LED light strip; and friction arising from interfaces among a surface of the LED light strip, the bracing structure and the protruding part holds the LED light assembly in place unless otherwise overcome by a lateral force upon the LED light strip.

In an embodiment, the LED light assembly is removable from the lamp tube by the lateral force without being damaged.

In an embodiment, a distance from the first left base to the second left base is identical to a distance from the first right base to the second right base. The distance from the first left base to the second left base is less than a distance from the second left base to the second right base.

In accordance with an exemplary embodiment of the present invention, the LED tube lamp comprises: a lamp tube, which includes a light transmissive portion, a reinforcing portion and an end cap; and an LED light assembly, which includes an LED light source and an LED light strip. The light transmissive portion is fixedly connected to the reinforcing portion. The reinforcing portion includes a plurality of bracing structures at endpoints and a plurality of protruding parts spaced apart between the endpoints. The bracing structure includes a combination of a vertical rib and a horizontal rib. The LED light strip abuts against the bracing structure, which holds the LED light assembly in place. The LED light source is thermally and electrically connected to the LED light strip, which is in turn connected to the reinforcing portion. The end cap is attached to an end of the lamp tube. A cross section of the lamp tube defines a hypothetical non-circle curve constructed by three hypothetical circles intersecting one another.

In an embodiment, the cross section of the lamp tube defines a first hypothetical circular triangle.

In an embodiment, the first hypothetical circular triangle has a trio of convex arc edges.

In an embodiment, the first hypothetical circular triangle has a pair of convex arc edges and a concave arc edge.

In an embodiment, vertices on the first circular triangle define a first hypothetical isosceles triangle including a base and a pair of legs.

In an embodiment, a fillet is configured on a vertex on the cross section of the lamp tube.

In an embodiment, a fillet is configured on all vertices on the cross section of the lamp tube.

In an embodiment, a fillet is configured on an interior corner of the vertex on the cross section of the lamp tube.

In an embodiment, a fillet is configured on an exterior corner of the vertex on the cross section of the lamp tube.

In an embodiment, a first fillet is configured on an interior corner of the vertex on the cross section of the lamp tube. A second fillet is configured on an exterior corner on the vertex opposite the interior corner of the vertex on the cross section of the lamp tube. The first fillet and the second fillet are spaced apart by a fixed normal distance.

In an embodiment, the fixed normal distance equals a thickness of the lamp tube adjacent to the filleted corner.

In an embodiment, a cross section of the end cap defines a second hypothetical circular triangle. The second hypothetical circular triangle has a trio of convex arc edges. Vertices on the second hypothetical circular triangle define a second hypothetical isosceles triangle.

In an embodiment, a fillet is configured on a vertex on the cross section of the end cap.

In an embodiment, a fillet is configured on all vertices on the cross section of the end cap.

In an embodiment, a fillet is configured on an interior corner of the vertex on the cross section of the end cap.

In an embodiment, a fillet is configured on an exterior corner of the vertex on the cross section of the end cap.

In an embodiment, the first hypothetical isosceles triangle and the second hypothetical isosceles triangle are parallel curves. The second hypothetical isosceles triangle encompasses the first hypothetical isosceles triangle.

In an embodiment, a bottom edge of a cross section of the reinforcing portion defines the base on the first hypothetical isosceles triangle.

In an embodiment, the bottom edge of the cross section of the reinforcing portion defines a first portion of the base on the first hypothetical isosceles triangle.

In an embodiment, the first portion of the base on the first hypothetical isosceles triangle is a middle portion on the base on the first hypothetical isosceles triangle.

In an embodiment, a cross section of the light transmissive portion defines: a right portion of the base on the first hypothetical isosceles triangle; a left portion of the base on the first hypothetical isosceles triangle; and the pair of legs on the first hypothetical isosceles triangle.

In an embodiment, the leg of length a is greater than the base of length b.

In an embodiment, the first hypothetical circular triangle having a vertex defines an axis of reflectional symmetry passing through the vertex.

In an embodiment, a cross section of an upper surface of the LED light strip defines a hypothetical line. The hypothetical line meets the perpendicular bisector of the first hypothetical isosceles triangle at a right angle.

In an embodiment, a perpendicular bisector of a hypothetical curve defined by the cross section of the lamp tube is divided by the hypothetical curve defined by the cross section of an inner surface of the lamp tube and the hypothetical line defined by the cross section of the upper surface of the LED light strip into an upper segment of length c and a lower segment of length d. The upper segment of length c is greater than the lower segment of length d.

In an embodiment, a perpendicular bisector of a hypothetical curve defined by the cross section of the lamp tube is divided by the hypothetical curve defined by the cross section of an inner surface of the lamp tube and the hypothetical line defined by the cross section of the upper surface of the LED light strip into an upper segment of length c and a lower segment of length d. The upper segment of length c is less than the lower segment of length d.

In an embodiment, the hypothetical line defined by the cross section of the LED light strip coincides with the base on the first hypothetical isosceles triangle.

In an embodiment, the hypothetical line defined by the cross section of the LED light strip rises above the base on the first hypothetical isosceles triangle.

In an embodiment, the hypothetical line defined by the cross section of the LED light strip sits below the base of the first hypothetical isosceles triangle.

In an embodiment, a plane figure defined by the first circular triangle and the pair of legs on the first hypothetical isosceles triangle has an area g. A plane figure defined by the first circular triangle and the base on the first hypothetical isosceles triangle has an area h. g to is greater than 2h.

In accordance with an exemplary embodiment of the present invention, the LED tube lamp comprises: a lamp tube, which includes a light transmissive portion, a reinforcing portion and an end cap; and an LED light assembly, which includes an LED light source and an LED light strip. The light transmissive portion is fixedly connected to the reinforcing portion. The reinforcing portion includes a plurality of bracing structures at endpoints of the reinforcing portion. The bracing structure includes a combination of a vertical rib and a horizontal rib. The LED light strip abuts against the bracing structure, which holds the LED light assembly in place. The LED light source is thermally and electrically connected to the LED light strip. The end cap is attached to an end of the lamp tube. A cross section of the lamp tube defines a non-circle hypothetical curve constructed by three hypothetical circles intersecting one another. The cross section of the lamp tube defines a first hypothetical circular triangle. The first hypothetical circular triangle has a trio of convex arc edges. Vertices on the first circular triangle define a first hypothetical isosceles triangle including a base and a pair of legs. A first fillet is configured on an interior corner of a vertex on the cross section of the lamp tube. A second fillet is configured on an exterior corner of the vertex on the cross section of the lamp tube. The first fillet and the second fillet are spaced apart by a first fixed normal distance. The first fixed normal distance equals a thickness of the lamp tube adjacent to the filleted corner. A cross section of the end cap defines a second hypothetical circular triangle. The second hypothetical circular triangle has a trio of convex arc edges. Vertices on the second hypothetical circular triangle define a second hypothetical isosceles triangle. A third fillet is configured on an interior corner of a vertex on the cross section of the end cap. A fourth fillet is configured on an exterior corner of the vertex on the cross section of the end cap. The third fillet and the fourth fillet are spaced apart by a second fixed normal distance. The second fixed normal distance equals a thickness of the end cap adjacent to the filleted corner. The first hypothetical isosceles triangle and the second hypothetical isosceles triangle are parallel curves. The second hypothetical isosceles triangle encompasses the first hypothetical isosceles triangle. A bottom edge of a cross section of the reinforcing portion defines a first portion of the base on the first hypothetical isosceles triangle. The first portion of the base on the first hypothetical isosceles triangle is a middle portion on the base on the first hypothetical isosceles triangle. A cross section of the light transmissive portion defines a right portion of the base on the first hypothetical isosceles triangle. A left portion of the base on the first hypothetical isosceles triangle; and the pair of legs on the first hypothetical isosceles triangle.

In an embodiment, the thickness of the lamp tube is the same as the thickness of the end cap.

Various other objects, advantages and features of the present invention will become readily apparent from the ensuing detailed description, and the novel features will be particularly pointed out in the appended claims.

### BRIEF DESCRIPTION OF THE DRAWINGS

The following detailed descriptions, given by way of example, and not intended to limit the present invention solely thereto, will be best be understood in conjunction with the accompanying figures:

FIG. 1 is a cross-sectional view of the LED tube lamp whose lamp tube includes a light transmissive portion and a reinforcing portion in accordance with an exemplary embodiment of the claimed invention;

FIG. 2 is a cross-sectional view of the LED tube lamp whose lamp tube includes a bracing structure in accordance with an exemplary embodiment of the claimed invention;

FIG. 3 is a perspective view of the LED tube lamp schematically illustrating the bracing structure shown in FIG. 2;

FIG. 4 is a perspective view of the LED tube lamp whose end cap has a non-circular cross section in accordance with an exemplary embodiment of the claimed invention;

FIG. 5 is a cross-sectional view illustrating a vertical rib on the lamp tube in accordance with an exemplary embodiment of the claimed invention;

FIG. 6 is a cross-sectional view illustrating the bracing structure in the lamp tube in accordance with an exemplary embodiment of the claimed invention;

FIG. 7 is a cross-sectional view illustrating a ridge, which extends in an axial direction along an inner surface of the lamp tube, in accordance with an exemplary embodiment of the claimed invention;

FIG. 8 is a cross-sectional view illustrating a compartment, which is defined by the bracing structure of the lamp tube, in accordance with an exemplary embodiment of the claimed invention;

FIG. 9 is a cross-sectional view illustrating the bracing structure of the lamp tube in accordance with an exemplary embodiment of the claimed invention;

FIG. 10 is a perspective view of the lamp tube shown in FIG. 9;

FIG. 11 is a cross-sectional view illustrating the bracing structure of the lamp tube in accordance with an exemplary embodiment of the claimed invention;

FIG. 12 is a cross-sectional view illustrating the LED light strip with a wiring layer in accordance with an exemplary embodiment of the claimed invention;

FIG. 13 is a perspective view of the lamp tube shown in FIG. 12;

FIG. 14 is cross-sectional view illustrating a protection layer disposed on the wiring layer in accordance with an exemplary embodiment of the claimed invention;

FIG. 15 is a perspective view of the lamp tube shown in FIG. 14;

FIG. 16 is a perspective view illustrating a dielectric layer disposed on the wiring layer adjacent to the lamp tube in accordance with an exemplary embodiment of the claimed invention;

FIG. 17 is a perspective view of the lamp tube shown in FIG. 16;

FIG. 18 is a cross-sectional view of the LED tube lamp whose lamp tube includes a light transmissive portion and a reinforcing portion in accordance with an exemplary embodiment of the claimed invention;

FIG. 19 is a cross-sectional view of the LED tube lamp whose lamp tube includes a light transmissive portion and a reinforcing portion in accordance with an exemplary embodiment of the claimed invention;

FIG. 20 (a) is a cross-sectional view of the LED tube lamp whose lamp tube has a triangular cross section in accordance with an exemplary embodiment of the claimed invention when the LED tube lamp is plugged into a light fixture;

FIG. 20 (b) is a cross-sectional view of the LED tube lamp whose lamp tube has a triangular cross section in accordance with another exemplary embodiment of the claimed invention when the LED tube lamp is plugged into a light fixture;

FIG. 21 is a cross-sectional view of the LED tube lamp whose lamp tube has a cross section defining a hypothetical isosceles triangle in accordance with an exemplary embodiment of the claimed invention;

FIG. 22 is a cross-sectional view of the LED tube lamp whose lamp tube has a cross section defining a hypothetical isosceles triangle in accordance with another exemplary embodiment of the claimed invention;

FIG. 23 is a cross-sectional view of the LED tube lamp whose lamp tube has a cross section defining a hypothetical triangle having curved edges in accordance with an exemplary embodiment of the claimed invention;

FIG. 24 is a perspective view of the LED tube lamp whose end cap has a cross section defining a hypothetical triangle having curved edges in accordance with an exemplary embodiment of the claimed invention;

FIG. 25 is a cross-sectional view of the LED tube lamp having a transitional edge on the corner of the lamp tube in accordance with an exemplary embodiment of the claimed invention;

FIG. 26 is a cross-sectional view of the LED tube lamp whose lamp tube has a cross section defining a hypothetical curve of constant width in accordance with an exemplary embodiment of the claimed invention; and

FIG. 27 is a cross-sectional view of the LED tube lamp whose lamp tube has a cross section defining a hypothetical curve constructed by a plurality of hypothetical circles intersecting one another in accordance with an exemplary embodiment of the claimed invention.

### DETAILED DESCRIPTION OF THE EMBODIMENTS

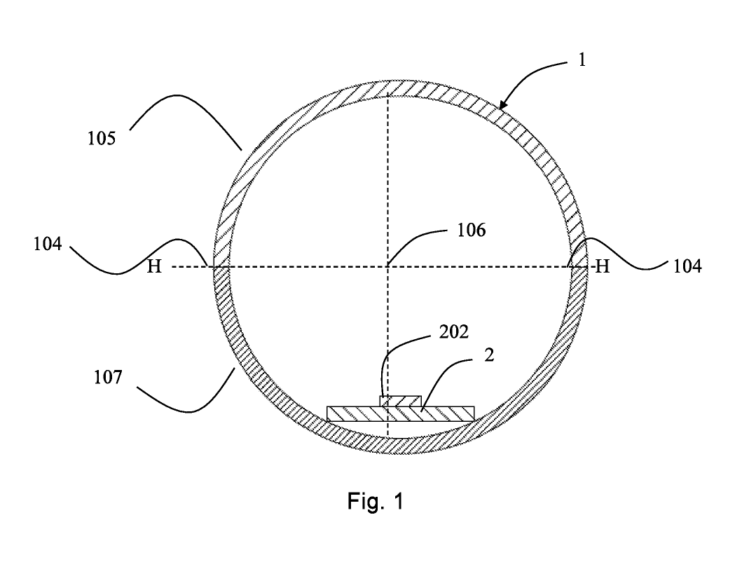

Referring to FIG. 1, in accordance with an exemplary embodiment of the claimed invention, the LED tube lamp comprises a lamp tube 1 and an LED light assembly. The lamp tube 1 includes a light transmissive portion 105 and a reinforcing portion 107. The reinforcing portion 107 is fixedly connected to the light transmissive portion 105.

The LED light assembly is disposed inside the lamp tube 1 and includes an LED light source 202 and an LED light strip 2. The LED light source 202 is thermally and electrically connected to the LED light strip 2, which is in turn thermally connected to the reinforcing portion 107. Heat generated by the LED light source 202 is first transmitted to the LED light strip 2 and then to the reinforcing portion 107 before egressing the lamp tube 1. Thermal connection is achieved with thermally conductive tapes or conventional mechanical fasteners such as screws aided by thermal grease to eliminate air gaps from interface areas.

Typically, the lamp tube 1 has a shape of an elongated cylinder, which is a straight structure. However, the lamp tube 1 can take any curved structure such as a ring or a horseshoe. The cross section of the lamp tube 1 defines—typically—a circle—or not as typically—an ellipse or a polygon. Alternatively, the cross section of the lamp tube 1 takes an irregular shape or any plane figure depending on the shapes of, respectively, the light transmissive portion 105 and the reinforcing portion 107 and on the manner the two portions interconnect to form the lamp tube 1.

The lamp tube 1 is a glass tube, a plastic tube or a tube made of any other suitable material or combination of materials. A plastic lamp tube is made from light transmissive plastic, thermally conductive plastic or a combination of both. The light transmissive plastic is one of translucent polymer matrices such as polymethyl methacrylate, polycarbonate, polystyrene, poly(styrene-co-methyl methacrylate) and a mixture thereof. Optionally, the strength and elasticity of thermally conductive plastic is enhanced by bonding a plastic matrix with glass fibers. When a lamp tube employs a combination of light transmissive plastic and thermally conductive plastic, the light transmissive plastic exhibits a greater optical transmittance but less thermal conductivity and structural strength than the thermally conductive plastic does in the combination. In an embodiment, an outer shell of lamp tube includes a plurality of layers made from distinct materials. For example, the lamp tube includes a plastic tube coaxially sheathed by a glass tube.

In an embodiment, the light transmissive portion 105 is made from light transmissive plastic. The reinforcing portion is 107 made from thermally conductive plastic. Injection molding is used for producing the light transmissive portion 105 in a first piece and for producing the reinforcing portion 107 in a separate second piece. The first piece and the second piece are configured to be clipped together, buckled together, glued together or otherwise fixedly interconnect to form the lamp tube 1. Alternatively, injection molding is used for producing the lamp tube 1, which includes the light transmissive portion 105 and the reinforcing portion 107, in an integral piece by feeding two types of plastic materials into a molding process. In an alternative embodiment, the reinforcing portion is made of metal having good thermal conductivity such as aluminum alloy and copper alloy.

Respective shapes of the light transmissive portion 105 and the reinforcing portion 107, how the two portions 105, 107 interconnect to form the lamp tube 1 and, particularly, the respective proportions of the two portions 105, 107 in the lamp tube depend on a desired totality of considerations such as field angle, heat dissipation efficiency and structural strength. A wider field angle—potentially at the expense of heat dissipation capability and structural strength—is achieved when the proportion of the light transmissive portion increases 105 in relation to that of the reinforcing portion 107. By contrast, the lamp tube benefits from an increased proportion of the reinforcing portion 107 in relation to that of the light transmissive portion in such ways as better heat dissipation and rigidity but potentially loses field angle.

In some embodiments, the reinforcing portion 107 includes a plurality of protruding parts. In other embodiments, a plurality of protruding parts are disposed on the surface of the LED light strip 2 that is not covered by the LED light assembly. Like fins on a heatsink, the protruding part boosts heat dissipation by increasing the surface area of the reinforcing portion 107 and the LED light strip 2. The protruding parts are disposed equidistantly, or alternatively, not equidistantly.

Staying on FIG. 1, the lamp tube 1 has a shape of a circular cylinder. Thus, a cross section of the lamp tube 1 defines a hypothetical circle. A line H-H cuts the circle horizontally into two equal halves along a diameter of the circle. A cross section of the light transmissive portion 105 defines an upper segment on the circle. A cross section of the reinforcing portion 107 defines a lower segment on the circle. A dividing line 104 parallel to the line H-H is shared by the two segments. In the embodiment, the dividing line 104 sits exactly on the line H-H. Consequently, the area of the upper segment is the same as that of the lower segment. In other words, the cross section of the light transmissive portion 105 has a same area as that of the reinforcing portion 107.

In an alternative embodiment, the dividing line 104 is spaced apart from the line H-H. For example, when the dividing line 104 is below the line H-H, the upper segment, which encompasses the light transmissive portion, has a greater area than the lower segment, which encompasses the reinforcing portion. The lamp tube, which includes an enlarged light transmissive portion, is thus configured to achieve a field angle wider than 180 degrees; however, other things equal, the lamp tube surrenders some heat dissipation capability, structural strength or both due to a diminished reinforcing portion 107. By contrast, the lamp tube 1 has an enlarged reinforcing portion 107 and a diminished light transmissive portion 105 if the dividing line rises above the line H-H. Other things equal, the lamp tube 1, now having an enlarged reinforcing portion 107, is configured to exhibit higher heat dissipation capability, structural strength or both; however, the field angle of the lamp tube 1 will dwindle due to diminished dimensions of the light transmissive portion 105.

The LED tube lamp is configured to convert bright spots coming from the LED light source into an evenly distributed luminous output. In an embodiment, a light diffusion layer is disposed on an inner surface of the lamp tube 1 or an outer surface of the lamp tube 1. In another embodiment, a diffusion laminate is disposed over the LED light source 202. In yet another embodiment, the lamp tube 1 has a glossy outer surface and a frosted inner surface. The inner surface is rougher than the outer surface. The roughness Ra of the inner surface is, preferably, from 0.1 to 40 μm, and most preferably, from 1 to 20 μm. Controlled roughness of the surface is obtained mechanically by a cutter grinding against a workpiece, deformation on a surface of a workpiece being cut off or high frequency vibration in the manufacturing system. Alternatively, roughness is obtained chemically by etching a surface. Depending on the luminous effect the lamp tube 1 is designed to produce, a suitable combination of amplitude and frequency of a roughened surface is provided by a matching combination of workpiece and finishing technique.

In alternative embodiment, the diffusion layer is in form of an optical diffusion coating, which is composed of any one of calcium carbonate, halogen calcium phosphate and aluminum oxide, or any combination thereof. When the optical diffusion coating is made from a calcium carbonate with suitable solution, an excellent light diffusion effect and transmittance to exceed 90% can be obtained.

In alternative embodiment, the diffusion layer is in form of an optical diffusion coating, which is composed of any one of calcium carbonate, halogen calcium phosphate and aluminum oxide, or any combination thereof. When the optical diffusion coating is made from a calcium carbonate with suitable solution, an excellent light diffusion effect and transmittance to exceed 90% can be obtained.

In the embodiment, the composition of the diffusion layer in form of the optical diffusion coating includes calcium carbonate, strontium phosphate (e.g., CMS-5000, white powder), thickener, and a ceramic activated carbon (e.g., ceramic activated carbon SW-C, which is a colorless liquid). Specifically, such an optical diffusion coating on the inner circumferential surface of the glass tube has an average thickness ranging between about 20 to about 30 μm. A light transmittance of the diffusion layer using this optical diffusion coating is about 90%. Generally, the light transmittance of the diffusion layer ranges from 85% to 96%. In addition, this diffusion layer can also provide electrical isolation for reducing risk of electric shock to a user upon breakage of the lamp tube 1. Furthermore, the diffusion layer provides an improved illumination distribution uniformity of the light outputted by the LED light sources 202 such that the light can illuminate the back of the light sources 202 and the side edges of the bendable circuit sheet to avoid the formation of dark regions inside the lamp tube 1 and improve the illumination comfort. In another possible embodiment, the light transmittance of the diffusion layer can be 92% to 94% while the thickness ranges from about 200 to about 300 μm.

In another embodiment, the optical diffusion coating can also be made of a mixture including calcium carbonate-based substance, some reflective substances like strontium phosphate or barium sulfate, a thickening agent, ceramic activated carbon, and deionized water. The mixture is coated on the inner circumferential surface of the glass tube and has an average thickness ranging between about 20 to about 30 μm. In view of the diffusion phenomena in microscopic terms, light is reflected by particles. The particle size of the reflective substance such as strontium phosphate or barium sulfate will be much larger than the particle size of the calcium carbonate. Therefore, adding a small amount of reflective substance in the optical diffusion coating can effectively increase the diffusion effect of light.

In other embodiments, halogen calcium phosphate or aluminum oxide can also serve as the main material for forming the diffusion layer. The particle size of the calcium carbonate is about 2 to 4 μm, while the particle size of the halogen calcium phosphate and aluminum oxide are about 4 to 6 μm and 1 to 2 μm, respectively. When the light transmittance is required to be 85% to 92%, the required average thickness for the optical diffusion coating mainly having the calcium carbonate is about 20 to about 30 μm, while the required average thickness for the optical diffusion coating mainly having the halogen calcium phosphate may be about 25 to about 35 μm, the required average thickness for the optical diffusion coating mainly having the aluminum oxide may be about 10 to about 15 μm. However, when the required light transmittance is up to 92% and even higher, the optical diffusion coating mainly having the calcium carbonate, the halogen calcium phosphate, or the aluminum oxide must be thinner.

The main material and the corresponding thickness of the optical diffusion coating can be decided according to the place for which the lamp tube 1 is used and the light transmittance required. It is to be noted that the higher the light transmittance of the diffusion layer is required, the more apparent the grainy visual of the light sources is.

In an embodiment, the LED tube lamp is configured to reduce internal reflectance by applying a layer of anti-reflection coating to an inner surface of the lamp tube 1. The coating has an upper boundary, which divides the inner surface of the lamp tube and the anti-reflection coating, and a lower boundary, which divides the anti-reflection coating and the air in the lamp tube 1. Light waves reflected by the upper and lower boundaries of the coating interfere with one another to reduce reflectance. The coating is made from a material with a refractive index of a square root of the refractive index of the light transmissive portion 105 of the lamp tube 1 by vacuum deposition. Tolerance of the coating's refractive index is ±20%. The thickness of the coating is chosen to produce destructive interference in the light reflected from the interfaces and constructive interference in the corresponding transmitted light. In an improved embodiment, reflectance is further reduced by using alternating layers of a low-index coating and a higher-index coating. The multi-layer structure is designed to, when setting parameters such as combination and permutation of layers, thickness of a layer, refractive index of the material, give low reflectivity over a broad band that covers at least 60%, or preferably, 80% of the wavelength range beaming from the LED light source 202. In some embodiments, three successive layers of anti-reflection coatings are applied to an inner surface of the lamp tube 1 to obtain low reflectivity over a wide range of frequencies. The thicknesses of the coatings are chosen to give the coatings optical depths of, respectively, one half, one quarter and one half of the wavelength range coming from the LED light source 202. Dimensional tolerance for the thickness of the coating is set at ±20%.

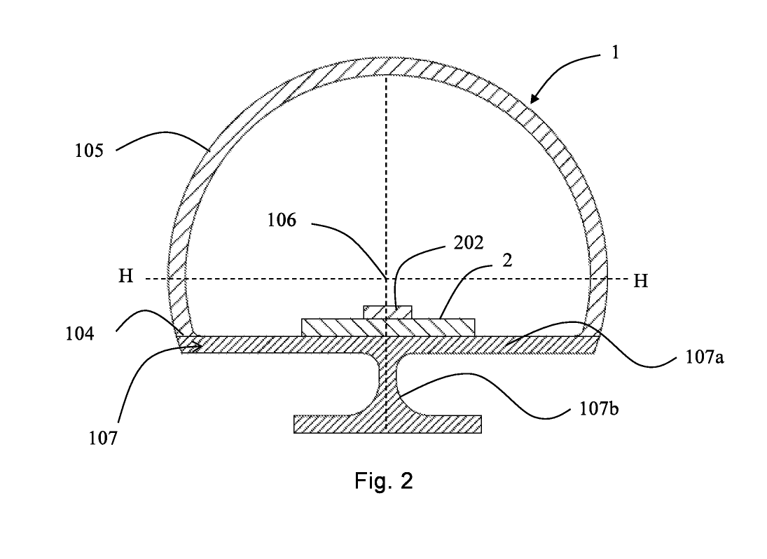

Turning to FIG. 2, in accordance with an exemplary embodiment of the claimed invention, the cross section of the lamp tube 1, unlike that of the cylindrical lamp tube 1 in FIG. 1, approximates an arc sitting on a flange of an I-beam. The lamp tube 1 includes a light transmissive portion 105 and a reinforcing portion 107. A cross section of the light transmissive portion 105 defines an upper segment on a hypothetical circle. A line H-H cuts the circle horizontally into two equal halves along a diameter of the circle. The reinforcing portion 107 includes a platform 107a and a bracing structure 107b. The platform 107a has an upper surface and a lower surface. The LED light assembly is disposed on the upper surface of the platform 107a. The bracing structure 107b is fixedly connected to the platform 107a and holds the platform 107a in place. The bracing structure 107b includes a horizontal rib, a vertical rib, a curvilinear rib or a combination of ribs selected from the above. The dimensions of the platform 107a, the horizontal rib and the vertical rib, their quantities and the manner they interconnect depend on a desired totality of considerations such as heat dissipation efficiency and structural strength. In the embodiment, the cross section of the reinforcing portion 107 approximates that of an I-beam. The platform 107a, the vertical rib and the horizontal rib correspond to, respectively, the upper flange, the web and the bottom flange of the I-beam. In other words, the bracing structure 107b includes exactly one vertical rib and exactly one horizontal rib.

A dividing line 104 parallel to the line H-H is shared by the upper segment and the upper flange. In the embodiment, the dividing line sits below the line H-H. Consequently, the upper segment constitutes the majority of the hypothetical circle. The light transmissive portion 105 is thus configured to generate a field angle wider than 180 degrees. In an alternative embodiment, the dividing line sits on or above the line H-H. For example, when the dividing line rises above the line H-H, the upper segment, which encompasses the light transmissive portion, now constitutes less than half of the hypothetical circle. The lamp tube 1, which has an enlarged reinforcing portion 107, is thus configured for better heat dissipation and structural strength; however, other things equal, the lamp tube 1 loses some luminous filed due to a diminished light transmissive portion 105.

In an embodiment, a surface on which the LED light assembly sits—e.g. the upper surface of the platform—is configured to further reflect the light reflected from the inner surface of the lamp tube 1. The surface on which the LED light assembly sits is coated with a reflective layer. Alternatively, the surface is finished to exhibit a reflectance of 80 to 95%, or preferably, 85 to 90%. Finishing is performed mechanically, chemically or by fluid jet. Mechanical finishing buffs a surface by removing peaks from the surface with an abrasive stick, a wool polishing wheel or a sandpaper. A surface treated this way has a roughness Ra as low as 0.008 to 1 μm. Chemical finishing works by dissolving peaks of a surface faster than troughs of the surface with a chemical agent. Fluid jet finishing uses a high-speed stream of slurry to accurately remove nanometers of material from a surface. The slurry is prepared by adding particles such as silicon carbide powder to a fluid capable of being pumped under relatively low pressure.

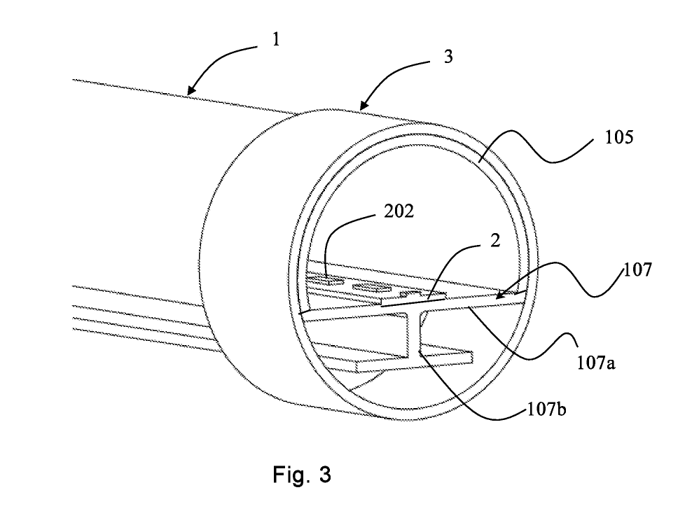

Turning to FIG. 3, in accordance with an exemplary embodiment of the claimed invention, the LED tube lamp further comprises an end cap 3, which is fixedly connected to an end of the lamp tube 1. The end cap 3 is made from plastic, metal or a combination of both. The end cap 3 and the lamp tube 1 are latched together, buckled together or otherwise mechanically fastened to one another. Alternatively, the two parts are glued together with hot-melt adhesive, e.g. a silicone matrix with a thermal conductivity of at least 0.7 Wm⁻¹K⁻¹.

Typically, the end cap 3 has a shape of a cylinder. The cross section of the end cap 3 thus defines a circle. Alternatively, the cross section of the end cap 3 takes an irregular shape depending on the shapes of, respectively, the light transmissive portion and the reinforcing portion and on the manner the two portions and the end cap 3 interconnect to form the LED tube lamp. Regardless of the shape of the end cap 3, the cross section of the end cap 3 encloses all or only a part of the cross section of the reinforcing portion 107 of the lamp tube 1. In the embodiment shown in FIG. 3, the end cap 3 defines a circular cylinder whose cross section encloses, entirely, the cross sections of, respectively, the light transmissive portion 105 and the reinforcing portion 107. The cross section of the lamp tube 1 approximates a segment, defined by the light transmissive portion 105, sitting on an upper flange of a hypothetical I-beam, defined by the reinforcing portion 107. A cross section of an inner surface of the end cap 3 defines a hypothetical circle. The hypothetical circle shares a same arc of the hypothetical segment defined by an outer surface of the light transmissive portion 105. The I-beam is enclosed, entirely, by the hypothetical circle.

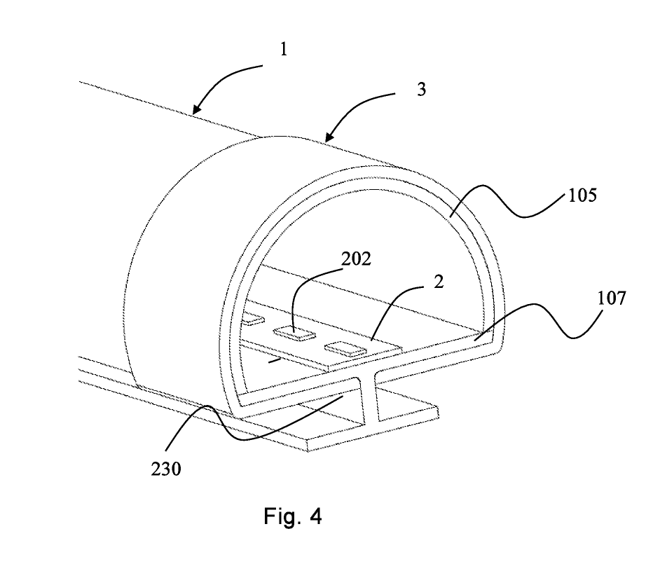

In an alternative embodiment shown in FIG. 4, the cross section of the end cap 3 encloses all of the cross section of the light transmissive portion 105 but only a part of that of the reinforcing portion 107. A cross section of the inner surface of the end cap 3 defines a same hypothetical segment defined by an outer surface of the light transmissive portion 105. However, only the upper flange of the hypothetical I-beam is enclosed by the hypothetical segment, but the lower flange and the web are not.

In some embodiments, an end of the LED light assembly extends to the end cap 3 as shown in FIGS. 3 and 4. In other embodiments, an end of the LED light assembly recedes from the end cap 3.

The bracing structure 107b may is made from a metallic material or plastic material. The metallic material is a pure metal, an alloy or a combination of pure metal and alloy having differentiated stiffness. Similarly, the plastic material is a single type of plastic or a combination of plastic materials having differentiated stiffness. Specifically, the plastic lamp tube 1 may include only one bracing structure with one stiffness or two bracing structures with various stiffness.

When only one bracing structure is adopted, the material of the only one bracing structure may be metal, metal alloy, or plastic, and the ratio of the cross-sectional area of the bracing structure to the cross-sectional area of the lamp tube 1 is from 1:3 to 1:30, or most preferably, from 1:5 to 1:10.

When more than one bracing structures with different stiffness are adopted, each of the bracing structures may be made of metal, metal alloy, or plastic. In one embodiment, when two bracing structures with different stiffness are adopted, the ratio of the cross-sectional area of the bracing structure with larger stiffness to the cross-sectional area of the other bracing structure is from 0.001:1 to 100:1, and the ratio of the cross-sectional area of the bracing structure with larger stiffness to the cross-sectional area of the lamp tube 1 is from 1:20 to 1:300.

In view of the bracing structure made of metal, the cross-section of the lamp tube 1 vertically cut by a hypothetical plane shows that the hypothetical plane may include the following 1. a lamp tube made of plastic, a first bracing structure made of a metal with a first stiffness, and a second bracing structure, such as a maintaining stick, made of a metal with a second stiffness different from the first stiffness; 2. a lamp tube made of plastic and a single bracing structure made of metal and/or metal alloy; or 3. a lamp tube made of plastic, a first bracing structure made of metal, and a second bracing structure, such as a maintaining stick, made of metal alloy. Similarly, various plastics with different stiffness may be used to serve as the bracing structures mentioned above according to embodiments of the present invention. As long as the materials for the used bracing structures have different stiffness, the materials are not limited. Thus, metal or metal alloy and plastic could also be served as materials for different bracing structures without departing from the spirit of the present invention. Additionally, the bracing structure is made from a material having a greater stiffness than a material from which the light transmissive portion is made.

In some embodiments, the lamp tube includes a first end cap fixedly connecting to a first end of the lamp tube and a second end cap fixedly connecting to a second end of the lamp tube. The first end cap is dimensionally larger—e.g. from 20% to 70% larger—than the second end cap.

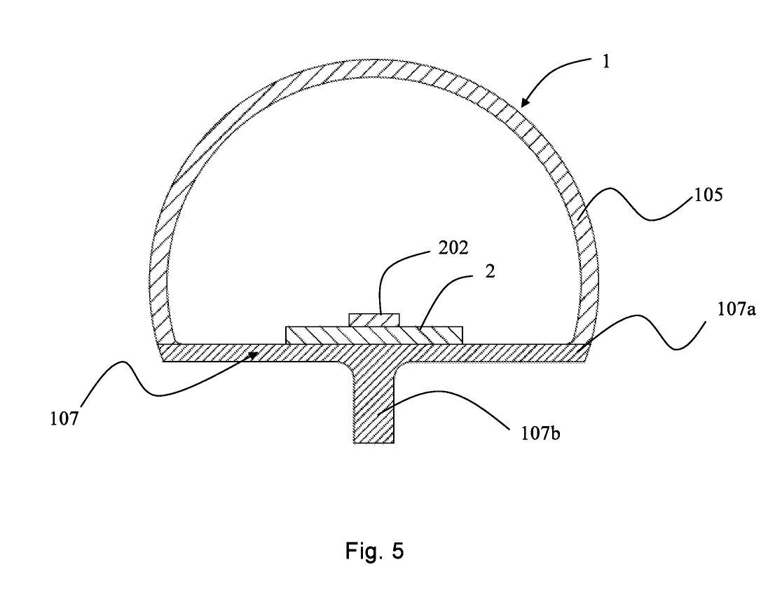

Shifting to FIG. 5, in accordance with an exemplary embodiment of the claimed invention, the cross section of the lamp tube 1 approximates an arc sitting on a flange of a hypothetical T-beam. The cross section of the reinforcing portion 107 approximates that of the T-beam. The platform 107a and the vertical rib correspond to, respectively, the flange and the web of the T-beam. In other words, the bracing structure 107b includes exactly one vertical rib but no horizontal rib. When the cross section of the end cap 3 encloses, entirely, the cross sections of, respectively, the light transmissive portion 105 and the reinforcing portion 107, other things equal, the vertical rib in a T-beam structure (FIG. 5) has a greater length than the vertical rib in an I-beam structure (FIG. 3).

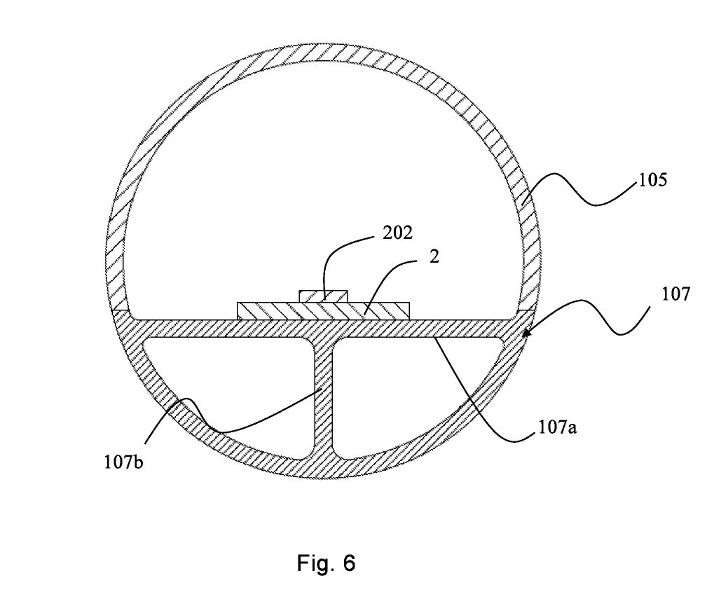

Turning to FIG. 6, in accordance with an exemplary embodiment of the claimed invention, the bracing structure 107b includes a vertical rib and a curvilinear rib but no horizontal rib. The cross section of the lamp tube 1 defines a hypothetical circle. A cross section of the light transmissive portion 105 defines an upper arc on the circle. A cross section of the curvilinear rib defines a lower arc on the circle. A cross section of the platform 107a and the vertical rib approximates that of a hypothetical T-beam. All three ends of the T-beam sit on the lower arc. The ratio of the length of the vertical rib to the diameter of the lamp tube 1 depends on a desired totality of considerations such as field angle, heatsinking efficiency and structural strength. Preferably, the ratio is from 1:1.2 to 1:30, or most preferably, from 1:3 to 1:10.

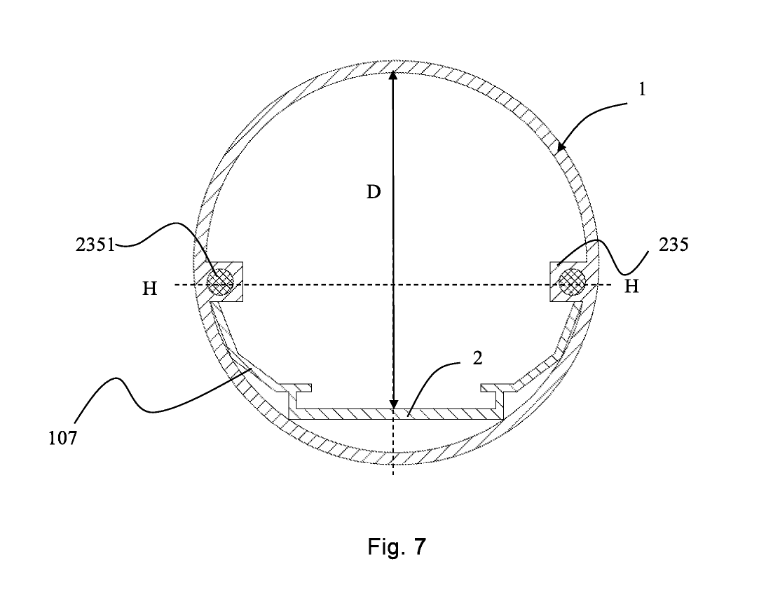

Turing to FIG. 7, in accordance with an exemplary embodiment of the claimed invention, the lamp tube 1 further includes a ridge 235. The ridge 235 extends in an axial direction along an inner surface of the lamp tube 1. The ridge 235 is an elongated hollow structure unbroken from end to end, or alternatively, broken at intervals. Injection molding is used for producing the reinforcing portion 107 and the ridge 235 in an integral piece. The position of the ridge 235 in relation to the line H-H bisecting the hypothetical circle defined by the lamp tube 1 depends on, as elaborated earlier, a desired totality of considerations such as field angle, heatsink efficiency and structural strength.

In an embodiment, the lamp tube 1 further includes a ridge 235 and a maintaining stick 2351. The maintaining stick 2351 is, likewise, an elongated structure, which is unbroken from end to end, or alternatively, broken at intervals, and which fills up the space inside the ridge 235. The maintaining stick 2351 is made of thermally conductive plastic, or alternatively, metal. The metal is one of carbon steel, cast steel, nickel chrome steel, alloyed steel, ductile iron, grey cast iron, white cast iron, rolled manganese bronze, rolled phosphor bronze, cold-drawn bronze, rolled zinc, aluminum alloy and copper alloy. The material from which the maintaining stick 2351 is made is chosen to provide the LED tube lamp with a combination of heat dissipation capability and structural strength that is otherwise absent from other parts of the lamp tube 1. In an embodiment, the maintaining stick 2351 is made from a different material than a material from which the LED light strip 2 or the reinforcing portion 107 is made. For example, when the LED light strip 2 or the reinforcing portion 107 of the lamp tube 1 is made from a metal having superior heat dissipation capability but insufficient stiffness, e.g. aluminum panel, the maintaining stick 2351 is made from a metal stiffer than aluminum to supply more structural strength. The ratio of the volume of heatsinking-oriented metal to the volume of stiffness-oriented metal in a lamp tube 1 is from 0.001:1 to 100:1, or most preferably, from 0.1:1 to 10:1. The ratio of the cross-sectional area of the maintaining stick 2351 to that of the lamp tube 1 is from 1:20 to 1:100, or most preferably, from 1:50 to 1:100.

In some embodiments, the lamp tube 1 includes a light transmissive portion and a reinforcing portion. In other embodiments, a ridge is substituted for the reinforcing portion. Thus, in these embodiments, the lamp tube 1 includes a light transmissive portion and a ridge, but no reinforcing portion. In an improved embodiment, the lamp tube 1 further includes a maintaining stick that fills up the space inside the ridge.

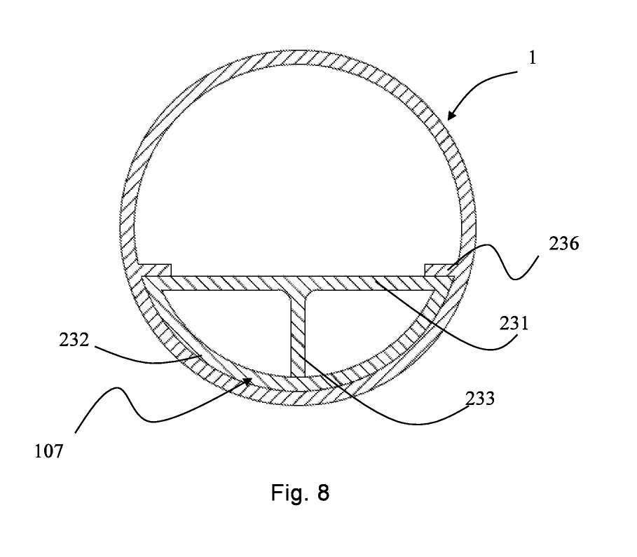

The outer surface of the reinforcing portion forms an outer surface of the lamp tube 1, as the embodiments in FIGS. 1-6. Alternatively, the outer surface of the reinforcing portion forms none of the outer surface of the lamp tube, as the embodiments in FIGS. 7-11. Where the reinforcing portion 107 is disposed entirely inside the lamp tube 1, the reinforcing portion 107 rests on the inner surface of the lamp tube 1 along a substantially uninterrupted interface, as the embodiment in FIG. 8; or alternatively, along an interrupted interface, as the embodiments in FIGS. 7, 9-11.

Focusing on FIG. 7, in accordance with an exemplary embodiment of the claimed invention, a first compartment is defined by the reinforcing portion 107 and the inner surface of the lamp tube 1. A second compartment is defined by the LED light strip 2 and the inner surface of the lamp tube 1. Likewise, in FIG. 8, a compartment is defined by the platform 231, the vertical rib 233 and the curvilinear rib 232. In some embodiments, a ridge is disposed inside the compartment for great structural strength. In other embodiments, a maintaining stick fills up the space inside the hollow structure of the ridge.

The length of the reinforcing portion, on which the LED light assembly is disposed, in the vertical direction in relation to the diameter of the lamp tube depends on the field angle the lamp tube is designed to produce. In the embodiment shown in FIG. 7, the ratio of the distance (D) between the LED light assembly and the dome of the lamp tube 1 to the diameter of the lamp tube 1 is from 0.25 to 0.9, or most preferably, from 0.33 to 0.75.

Turning to FIG. 8, in accordance with an exemplary embodiment of the claimed invention, the lamp tube further includes a pair of protruding bars 236. The protruding bar 236 extends in an axial direction along an inner surface of the lamp tube 1 and is configured to form a guiding channel inside the lamp tube 1. The reinforcing portion 107 is connected to the lamp tube 1 by sliding the reinforcing portion 107 into the guiding channel. In the embodiment, a cross section of an inner surface of the lamp tube 1 defines a hypothetical circle. A cross section of the curvilinear rib 232 defines a lower arc on the circle. A cross section of the platform 231 and the vertical rib 233 approximates that of a hypothetical T-beam. All three ends of the T-beam sit on the lower arc. The pair of protruding bars 236 and the inner surface of the lamp tube 1 form the guiding channel in the lamp tube 1. The cross section of the guiding channel is defined by the flange of the T-beam and the lower arc. The reinforcing portion 107 is thus configured to fit snugly into the guiding channel.

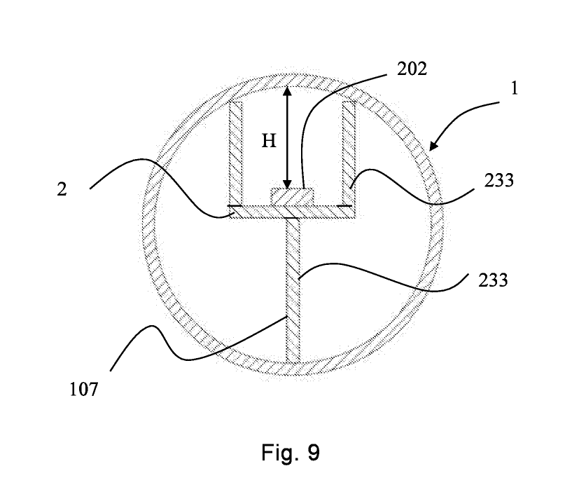

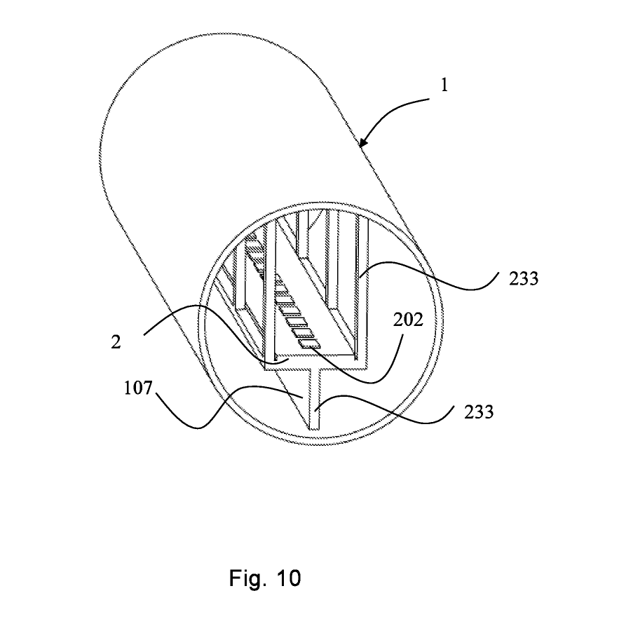

Turning to FIGS. 9 and 10, in accordance with an exemplary embodiment of the claimed invention, the reinforcing portion includes a plurality of vertical ribs 233. The vertical rib 233 is fixedly connected to the inner surface of the lamp tube 1 on one end and to the LED light strip 2 on the other end. The LED light assembly is thus spaced apart from inner surface of the plastic lamp tube 1. The plastic lamp tube 1 is protected from heat generated by the LED light assembly because the heat is taken away from the lamp tube 1 by the plurality of the vertical ribs 233. A cross section of the lamp tube 1 cuts through an LED light source 202, a first vertical rib 233 connected to an upper surface of the LED light assembly, a second vertical rib 233 connected to a lower surface of the LED light assembly or any combination of the above. In other words, the LED light assembly, the first vertical rib 233 and the second vertical rib 233 are aligned with one another, or alternatively, staggered. In an embodiment, the second vertical rib 233 connected to the lower surface of the LED light assembly is an unbroken structure extending along the longitudinal axis of the lamp tube 1 for better heat dissipation and more structural strength. In FIG. 10, the plurality of first vertical ribs 233 are spaced apart from one another like an array of pillars. However, the second vertical rib 233 extends uninterruptedly between the lower surface of the LED light assembly and the lamp tube 1 like a wall.

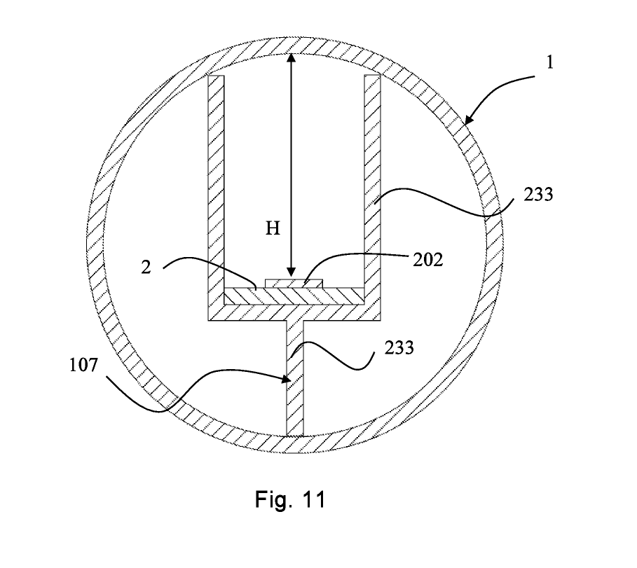

Turning to FIG. 11, in accordance with an exemplary embodiment of the claimed invention, the reinforcing portion 107 further includes a platform. The vertical rib 233 is fixedly connected to, instead of the LED light assembly, the platform on one end and to the inner surface on the other end. The vertical ribs 233 and the platform are thus one integral structure. The LED light assembly is thermally connected to an upper surface of the platform.

The position of the LED light strip 2 inside the lamp tube 1—i.e. the length of the first vertical rib 233 and the length of the second vertical rib 233—is chosen in light of a desired totality of factors such as field angle, heat-dissipating capability and structural strength. In FIGS. 9 and 11, the ratio of the distance (H) between the LED light strip 2 and the dome of the lamp tube 1 to the diameter of the lamp tube 1 is from 0.25 to 0.9, or most preferably, from 0.33 to 0.75.

Going back to FIG. 1, in accordance with an exemplary embodiment of the invention, the LED tube lamp comprises a lamp tube 1, which includes a light transmissive portion 105, a reinforcing portion 107 and an end cap (omitted from FIG. 1). The LED tube lamp further includes an LED light assembly, which includes an LED light source 202 and an LED light strip 2. The LED light source 202 is thermally and electrically connected to the LED light strip 2, which is in turn thermally connected to the reinforcing portion 107. The end cap is attached to an end of the lamp tube 1. In an embodiment, the lamp tube is a monolithic structure including the light transmissive portion and the reinforcing portion. In some embodiments, the monolithic structure shares a homogenous set of chemical properties, physical properties or both throughout the entire structure. Being structurally indistinctive, the monolithic structure need not be materially uniform throughout the entire structure. In an embodiment, the monolithic structure includes a first region and a second region having distinctive sets of chemical properties, physical properties or both. For example, a first region of the monolithic structure is flexible; a second region of the monolithic structure is less flexible than the first region. In some embodiments, the lamp tube includes a set of structurally distinctive layers or modules interconnected to form the lamp tube in a unitary structure. In an embodiment, the lamp tube includes a sequence of layers to form the lamp tube in a unitary structure. For example, a first layer is the light diffusing layer; a second layer is the heatsinking layer on top of the first layer. In another embodiment, the lamp tube includes a set of prefabricated modules assembled to form the lamp tube in a unitary structure. A module is unifunctional or multifunctional. For example, the light transmissive portion is found exclusively in a first module; the reinforcing portion is found exclusively in a second module. Alternatively, the light transmissive portion and the reinforcing portion are found—in part at least—in a multifunctional module.

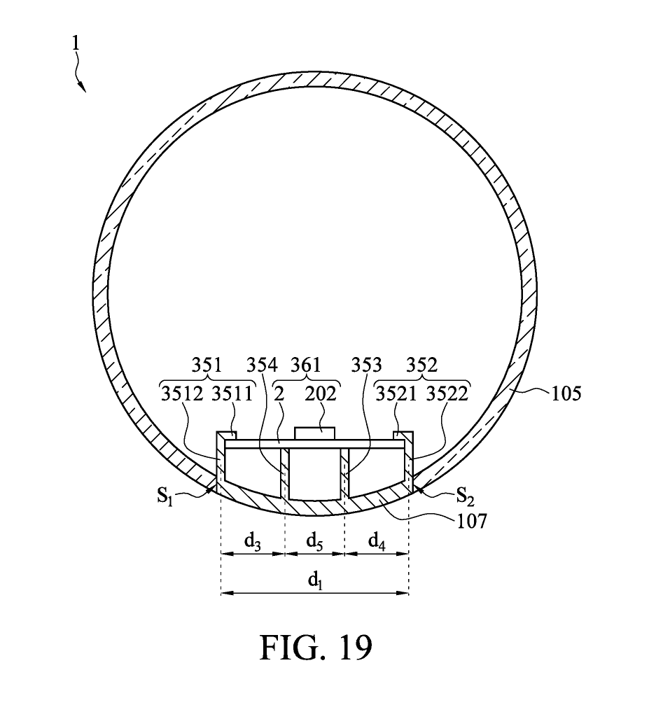

Shifting to FIG. 19, in an embodiment, the light transmissive portion 105 is fixedly connected to the reinforcing portion 107. The reinforcing portion 107 includes a plurality of bracing structures 351, 352 at endpoints S₁, S₂ of the reinforcing portion 107 and a plurality of protruding parts 353, 354 spaced apart between the endpoints S₁, S₂ of the reinforcing portion 107. The bracing structure 351, 352 includes a combination of vertical ribs 3512, 3522 and horizontal ribs 3511, 3521. The LED light strip 2 abuts against the bracing structure 351, 322 to stay in place between the bracing structures 351, 352 in the lamp tube 1. The LED light assembly 361 receives upright support from and rests upon the plurality of protruding parts 353, 354. In the embodiment in FIG. 19, the reinforcing portion 107 includes a pair of bracing structures 351, 352 and a pair of protruding parts 353, 354. The pair of bracing structures 351, 352 includes a left vertical rib 3512, a left horizontal rib 3511, a right vertical rib 3522 and a right horizontal rib 3521. The left vertical rib 3512 having a first left base extends upwards from S₁ at which the light transmissive portion 105 and the reinforcing portion 107 merge. The left horizontal rib 3511 merges with the left vertical rib 3512 at a point slightly higher than an upper surface of the LED light strip 2. The right vertical rib 3522 having a first right base extends upwards from S₂ at which the light transmissive portion 105 and the reinforcing portion merge 107. The right horizontal rib 3521 merges with the right vertical rib 3522 at a point slightly higher than the upper surface of the LED light strip 2. The LED light assembly 361 is kept in position in the lamp tube 1 between the space defined by the pair of bracing structures 351, 352 and the pair of protruding parts 353, 354. In an embodiment, a distance between the first left base and the first right base d₁ is slightly greater than a width of the LED light strip 2 in its relaxed condition. In another embodiment, a distance between the first left base and the first right base d₁ is slightly less than a width of the LED light strip 2 in its relaxed condition. In yet another embodiment, the LED light strip 2 is made from a flexible material. A distance between the first left base and the first right base d₁ is less than a width of the LED light strip 2 in its relaxed condition to pinch the LED light strip 2 into a desired curve on the cross section of the lamp tube 1.

Staying on FIG. 19, in an embodiment, the left protruding part 354 having a second left base erects from a point closer to S₁ than S₂ between S₁ and S₂ on the reinforcing portion 107 towards a lower surface of the LED light strip 2. The right protruding part 353 having a second right base erects from a point closer to S₂ than S₁ between S₁ and S₂ on the reinforcing portion 107 towards the lower surface of the LED light strip 2. In an embodiment, a distance from the first left base to the second left base d₃ is identical to a distance from the first right base to the second right base d₄. In another embodiment, a distance from the first left base to the second left base d₃ is greater than a distance from the first right base to the second right base d₄. In yet another embodiment, a distance from the first left base to the second left base d3 is less than a distance from the first right base to the second right base d4. In an embodiment, the distance from the first left base to the second left base d₃ is identical to a distance from the second left base to the second right base d₅. In another embodiment, the distance from the first left base to the second left base d₃ is greater than a distance from the second left base to the second right base d₅. In yet another embodiment, the distance from the first left base to the second left base d₃ is less than a distance from the second left base to the second right base d₅. In an embodiment, friction arising from interfaces among a surface of the LED light strip 2, the bracing structure 351, 352 and the protruding part 353, 354 fixes the LED light assembly 361 in place in the lamp tube 1. In some embodiments, the friction can be overcome by a lateral force upon the LED light strip 2 without damaging the LED light assembly 361. The LED light assembly 361 is removable from the lamp tube 1 with a non-destructive force. In other embodiments, the friction cannot be overcome by a lateral force without damaging the LED light assembly 361.

In accordance with an exemplary embodiment of the invention, the cross section of the lamp tube defines a hypothetical polygon. The hypothetical polygon is a simple polygon with a plurality of edges. Alternatively, the hypothetical polygon is a self-intersecting polygon in which an edge of the polygon crosses itself. The hypothetical polygon is a convex polygon in which all its interior angles are less than 180°. Alternatively, the hypothetical polygon is a concave polygon in which at least one interior angle is greater than 180°. The hypothetical polygon is bounded by and only by straight line segments closing in a loop. Alternatively, the hypothetical polygon includes at least one edge which is a curve. In an embodiment, only two edges of the hypothetical polygon are curved. In another embodiment, all edges of the hypothetical polygon are curved. The non-straight edge is curved inwards. Alternatively, the non-straight edge is curved outwards. In an embodiment, all edges of the hypothetical polygon are curved outwards. In another embodiment, all edges of the hypothetical polygon are curved inwards. In yet another embodiment, the hypothetical polygon includes an edge curved inwards but another edge curved outwards. In an embodiment, all curved edges have a same curvature. In another embodiment, a first curved edge has a greater curvature than a second curved edge. In yet another embodiment, no curved edges have a same curvature.

A cross section of the lamp tube includes an outer edge and an inner edge. In an embodiment, the outer edge and the inner edge are spaced apart by a fixed distance throughout the cross section. In another embodiment, the outer edge and the inner edge are spaced apart by a first distance at a first point of the cross section but by a second distance—which is greater than the first distance—at a second point of the cross section. In yet another embodiment, the outer edge and the inner edge are spaced apart by exactly one of the first distance and the second distance.

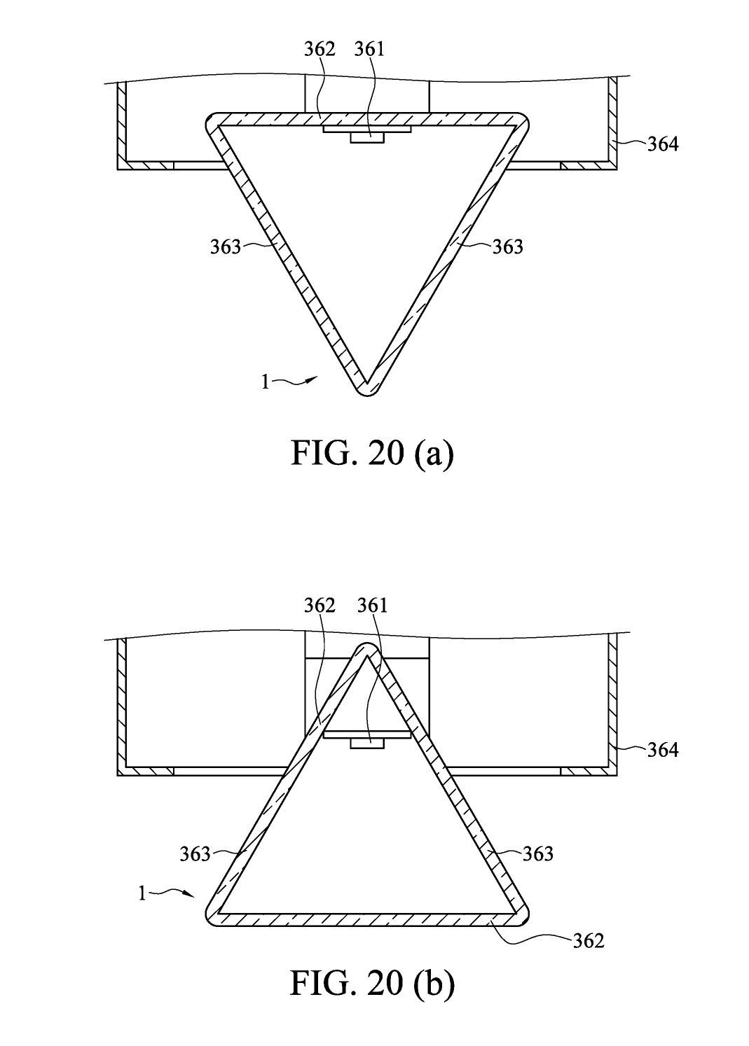

A cylindrical lamp tube (e.g. FIG. 1) generates a same luminous field regardless of its orientation because the cross section of the cylindrical lamp tube looks the same when the lamp tube rotates around its longitudinal axis in a lighting fixture. By contrast, a lamp tube with a cross section in a shape having a finite degree of rotational symmetry (e.g. a triangle) will produce different luminous fields depending on its orientation in the lighting fixture. Cave effect occurs when an LED tube lamp directs light in a beam strongly focused downwards, resulting in little light reaching the ceiling. The top portion of the room is considerably darker than the floor or the working plane. The cave effect is exacerbated if the color of the ceiling is dark. There is a negative effect on the personnel motivation due to a gloomy and visually uncomfortable environment so created. Shifting to FIG. 20 (a), other things equal, the lamp tube 1 having a triangular cross section mitigates the cave effect by providing a wider spread of its luminous output when the pair of lateral faces 363, 363 reveal themselves as the illuminating surfaces and the third face 362 (on which the LED light assembly 361 rests) is hidden from view in the lighting fixture 364 or the troffer 364. However, in FIG. 20 (b), the third surface 362 reveals itself—and probably some lateral faces 363, 363—as the primary illuminating surface beaming most of the light downwards while the pair of lateral faces 363, 363 (over which the LED light assembly 361 straddles) are partially hidden from view in the light fixture 364 or the troffer 364 if cave effect is desirable for decorative purposes.

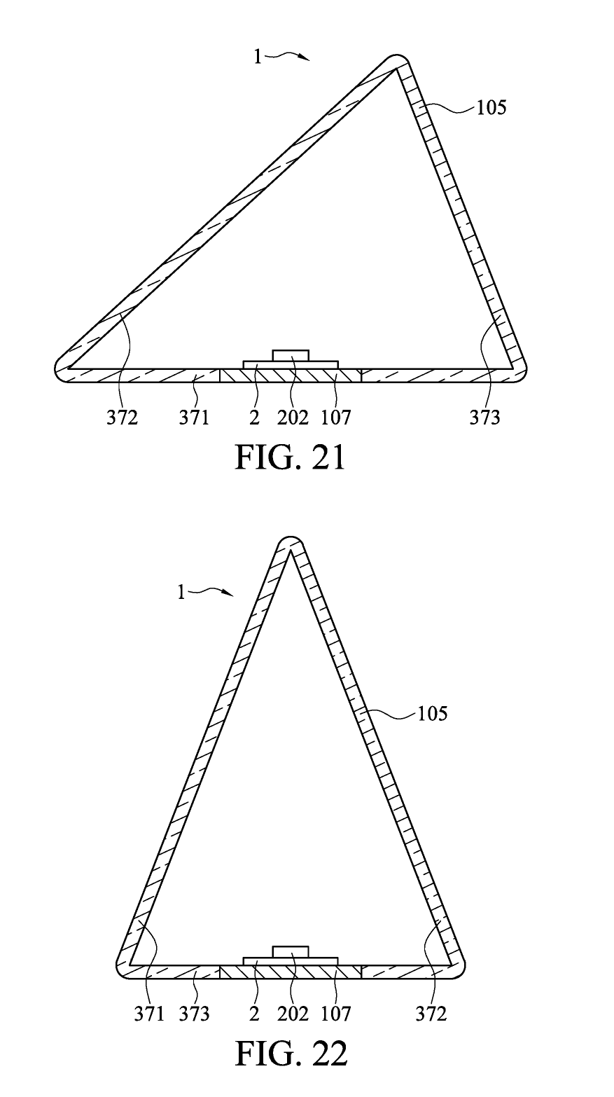

Shifting to FIGS. 21 and 22, in an embodiment, the cross section of the lamp tube defines a hypothetical triangle. In another embodiment, the cross section of the lamp tube defines a hypothetical equilateral triangle. In yet another embodiment in FIGS. 21 and 22, the cross section of the lamp tube 1 defines a hypothetical isosceles triangle, which includes a base 373 and a pair of legs 371, 372. The lamp tube defines the hypothetical isosceles triangle in a variety of ways. In an embodiment, the first leg on the hypothetical isosceles triangle is defined exclusively by the bottom edge of the cross section of the reinforcing portion. In the embodiment in FIG. 21, the bottom edge of the cross section of the reinforcing portion 107 defines a first portion of the first leg 371 on the hypothetical isosceles triangle. In an embodiment, the first portion of the first leg 371 on the hypothetical isosceles triangle is the middle portion on the first leg 371 on the hypothetical isosceles triangle. The cross section of the light transmissive portion 105 defines the right portion of the first leg 371 on the hypothetical isosceles triangle; the left portion of the first leg 371 on the hypothetical isosceles triangle; the second leg 372 on the hypothetical isosceles triangle; and the base 373 on the hypothetical isosceles triangle. In another embodiment, the bottom edge of a cross section of the reinforcing portion defines the base on the first hypothetical isosceles triangle. In an embodiment, the base on the hypothetical isosceles triangle is defined exclusively by the bottom edge of the cross section of the reinforcing portion. In the embodiment in FIG. 22, the bottom edge of the cross section of the reinforcing portion 107 defines a first portion of the base 373 on the hypothetical isosceles triangle. In an embodiment, the first portion of the base 373 on the hypothetical isosceles triangle is the middle portion of the base 373 on the hypothetical isosceles triangle. The cross section of the light transmissive portion 105 defines the right portion of the base 373 on the hypothetical isosceles triangle; the left portion of the base 373 on the hypothetical isosceles triangle; and the pair of legs 371, 372 on the hypothetical isosceles triangle. In an embodiment, the leg of length a is greater than the base of length b. In an embodiment, the ratio a/b is from 1.05 to 1.5. Alternatively, the leg of length a is less than the base of length b. In an embodiment, the ratio a/b is from 0.75 to 0.95.

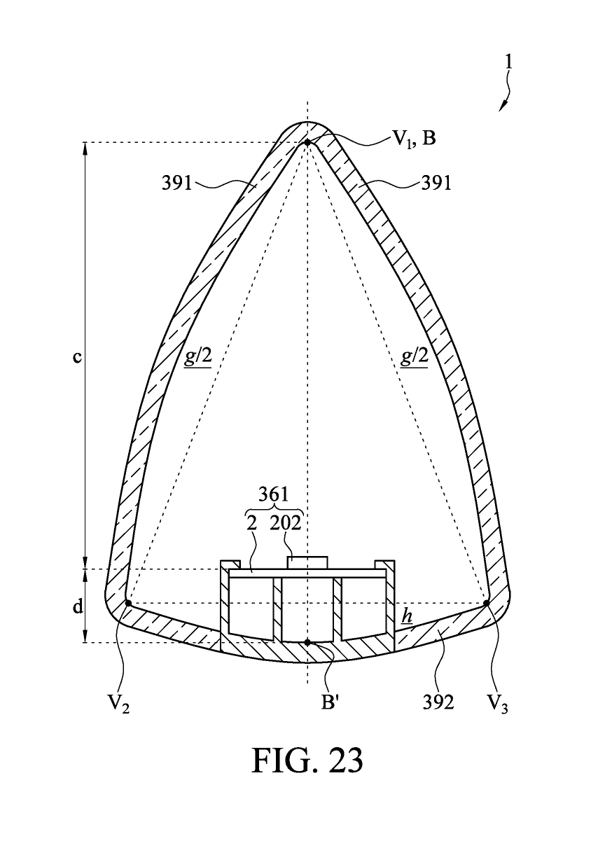

Turning to FIG. 23, in an embodiment, all edges 391, 391, 392 on the hypothetical triangle defined by the cross section of the lamp tube 1 are slightly curved outwards. In another embodiment, all edges on the hypothetical triangle are slightly curved inwards. In yet another embodiment, the hypothetical triangle includes an edge slightly curved inwards but another edge slightly curved outwards. For example, the hypothetical isosceles triangle includes a base slightly curved inwards and a leg slightly curved outwards. Alternatively, the hypothetical isosceles triangle includes a base slightly curved outwards and a leg slightly curved inwards. The slightly curved edge is a closed segment of any differentiable curve. In an embodiment, the slightly curved edge is a circular arc. In another embodiment, the slightly curved edge is a parabolic arc. In yet another embodiment, the slightly curved edge is an elliptical arc. In the embodiment in FIG. 23, the cross section of the lamp tube 1 has reflectional symmetry. The perpendicular bisector B-B′ of the hypothetical isosceles triangle having edges 391, 391, 392 curved outwards defined by the cross section of the lamp tube 1 coincides with the perpendicular bisector B-B′ of the hypothetical isosceles triangle V₁-V₂-V₃ having straight edges V₁-V₂, V₂-V₃ defined by the vertices V₁, V₂, V₃ of the hypothetical isosceles triangle defined by the cross section of the lamp tube 1. In another embodiment, the cross section of the lamp tube violates reflectional symmetry. The perpendicular bisector of the hypothetical isosceles triangle having edges curved outwards defined by the lamp tube diverges from a perpendicular bisector of the hypothetical isosceles triangle having straight edges defined by the vertices of the hypothetical isosceles triangle defined by the cross section of the lamp tube. The cross section of the LED light strip 2 defines a hypothetical line. In an embodiment, the hypothetical line meets the perpendicular bisector B-B′ of the hypothetical isosceles triangle defined by the cross section of lamp tube 1 at a right angle. In another embodiment, the hypothetical line defined by the cross section of the LED light strip meets the perpendicular bisector of the hypothetical isosceles triangle defined by the cross section of the lamp tube at a non-right angle.

Staying on FIG. 23, the higher the LED light assembly 361 finds itself in the lamp tube 1, the greater the space is underneath the LED light assembly 361 for air to carry heat away from the LED light source 202. By contrast, the lower the LED light assembly 361 finds itself in the lamp tube 1, the wider the field angle is illuminated by the LED tube lamp—other things equal—at the expense of heatsinking efficiency. A perpendicular bisector B-B′ of a hypothetical curve defined by the cross section of the lamp tube 1 is divided by the hypothetical curve defined by the cross section of the inner surface of the lamp tube 1 and the hypothetical line defined by the cross section of the upper surface of the LED light strip 2 into an upper segment of length c and a lower segment of length d. In the embodiment in FIG. 23, the upper segment of length c is greater than the lower segment of length d. In an embodiment, the ratio c/d is from 5 to 15. In another embodiment, the upper segment of length c is less than the lower segment of length d. In an embodiment, the ratio c/d is from 0.4 to 0.9. In yet another embodiment, the upper segment of length c is equal to the lower segment of length d.

Still on FIG. 23, the higher the LED light assembly 361 finds itself in the lamp tube 1, the greater the space is underneath the LED light assembly 361 for air to carry heat away from the LED light assembly 361. By contrast, the lower the LED light assembly 361 finds itself in the lamp tube 1, the wider the field angle is illuminated by the LED tube lamp—other things equal—at the expense of heatsinking efficiency. In an embodiment, the hypothetical line defined by the cross section of the LED light strip coincides with the base on the hypothetical isosceles triangle defined by the vertices on the hypothetical isosceles triangle having edges curved outwards defined by the cross section of the lamp tube. In the embodiment in FIG. 23, the hypothetical line defined by the cross section of the LED light strip 2 rises above the base V₂-V₃ on the hypothetical isosceles triangle V₁-V₂-V₃ defined by the vertices V₁, V₂, V₃ on the hypothetical isosceles triangle having edges curved outwards defined by the cross section of the lamp tube 1. In yet another embodiment, the hypothetical line defined by the cross section of the LED light strip sits below the base on the hypothetical isosceles triangle defined by the vertices on the hypothetical isosceles triangle having edges curved outwards defined by the cross section of the lamp tube.

Still on FIG. 23, plane figures defined by the curved pair of legs 391, 391 on the hypothetical isosceles triangle defined by the cross section of the lamp tube 1 and the straight pair of legs V₁-V₃, V₁-V₂ on the hypothetical isosceles triangle V₁-V₂-V₃ defined by the vertices V₁, V₂, V₃ on the hypothetical isosceles triangle defined by the cross section of the lamp tube 1 encompass an area g (g/2+g/2). A plane figure defined by the curved base 392 on the hypothetical isosceles triangle defined by the cross section of the lamp tube 1 and the straight base V₂-V₃ on the hypothetical isosceles triangle V₁-V₂-V₃ defined by the vertices V₁, V₂, V₃ on the hypothetical isosceles triangle defined by the cross section of the lamp tube 1 encompasses an area h. In an embodiment, g is equal to 2h. In another embodiment, g is greater than 2h. In an embodiment, the ratio g/h is from 2.1 to 4. In the embodiment in FIG. 23, g is less than 2h. In an embodiment, the ratio g/h is from 0.33 to 1.95.

Still on FIG. 23, fillets on points of expected high stress—e.g. vertices V₁, V₂, V₃ on the cross section of the lamp tube 1—reduce stress concentration because the fillets distribute the stress over a broader area and make the LED tube lamp more durable and capable of withstanding rough handling. In an embodiment, a fillet is configured on a vertex on the cross section of the lamp tube. In the embodiment in FIG. 23, a fillet is configured on all vertices V₁, V₂, V₃ on the cross section of the lamp tube 1. In an embodiment, a fillet is configured on an interior corner of the vertex on the cross section of the lamp tube. In another embodiment, a fillet is configured on an exterior corner of the vertex on the cross section of the lamp tube. In the embodiment in FIG. 23, a first fillet is configured on an interior corner of a vertex V₁ (or V₂, V₃) on the cross section of the lamp tube 1. A second fillet is configured on an exterior corner of the vertex V₁ (or V₂, V₃) on the cross section of the lamp tube 1. The first fillet and the second fillet are spaced apart by a fixed normal distance. In the embodiment in FIG. 23, the fixed normal distance equals the thickness of the lamp tube 1. In another embodiment, the fixed normal distance is greater than the thickness of the lamp tube. In yet another embodiment, the fixed normal distance is less than the thickness of the lamp tube. In an embodiment, the fixed normal distance is the same as the thickness of the end cap. In another embodiment, the fixed normal distance is greater than the thickness of the end cap. In yet another embodiment, the fixed normal distance is greater than the thickness of the lamp tube.

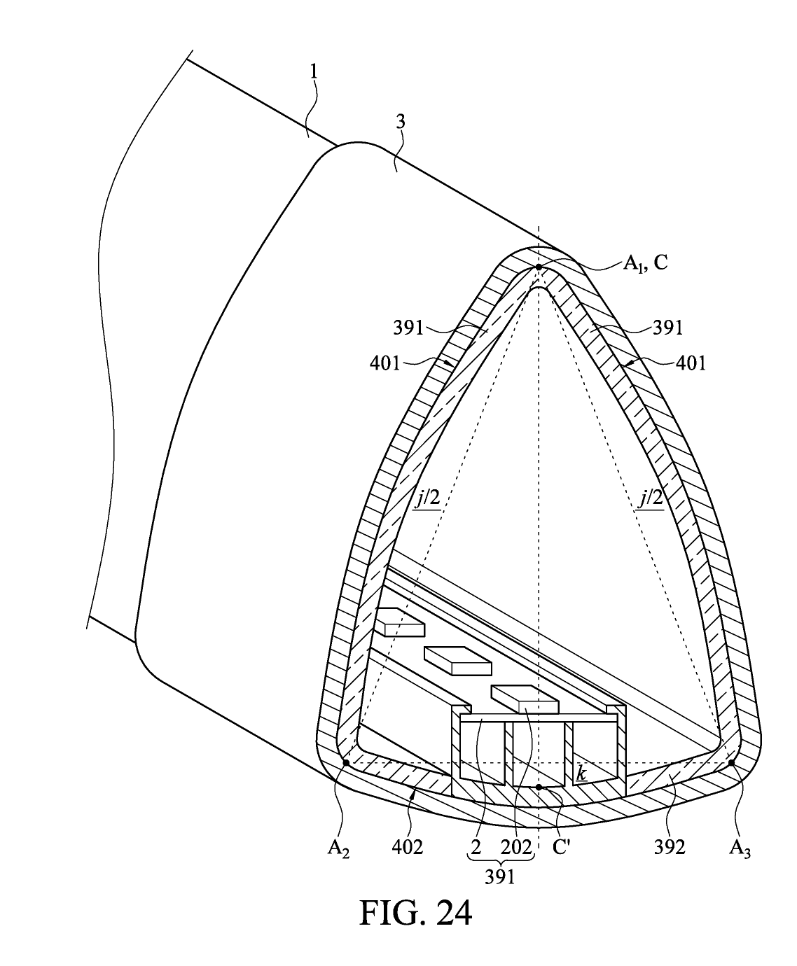

Turning to FIG. 24, in an embodiment, the cross section of the end cap 3 defines a hypothetical polygon. The hypothetical polygon is a simple polygon with any number of edges. Alternatively, the hypothetical polygon is a self-intersecting polygon in which an edge of the polygon crosses itself. The hypothetical polygon is a convex polygon in which all its interior angles are less than 180°. Alternatively, the hypothetical polygon is a concave polygon in which at least one interior angle is greater than 180°. The hypothetical polygon is bounded by and only by straight line segments closing in a loop. Alternatively, the hypothetical polygon includes at least one edge which is a curve. In an embodiment, only two edges of the hypothetical polygon are curved. In another embodiment, all edges of the hypothetical polygon are curved. The non-straight edge is curved inwards. Alternatively, the non-straight edge is curved outwards. In the embodiment in FIG. 24, all edges 401, 401, 402 of the hypothetical polygon are curved outwards. In another embodiment, all edges of the hypothetical polygon are curved inwards. In yet another embodiment, the hypothetical polygon includes an edge curved inwards but another edge curved outwards.

Staying on FIG. 24, in an embodiment, the cross section of the end cap 3 defines a hypothetical triangle. In another embodiment, the cross section of the end cap defines a hypothetical equilateral triangle. In the embodiment in FIG. 24, the cross section of the end cap 3 defines a hypothetical isosceles triangle, which includes a base 402 and a pair of legs 401, 401. In the embodiment in FIG. 24, all edges 401, 401, 402 on the hypothetical isosceles triangle are slightly curved outwards. In another embodiment, all edges on the hypothetical isosceles triangle are slightly curved inwards. In yet another embodiment, the hypothetical isosceles triangle includes an edge slightly curved inwards but another edge slightly curved outwards. The slightly curved edge is a closed segment of any differentiable curve. In an embodiment, the slightly curved edge is a circular arc. In another embodiment, the slightly curved edge is a parabolic arc. In yet another embodiment, the slightly curved edge is an elliptical arc.

Still on FIG. 24, in an embodiment, the cross section of the end cap 3 has reflectional symmetry. The perpendicular bisector C-C′ of the hypothetical isosceles triangle having edges 401, 401, 402 curved outwards defined by the cross section of the end cap 3 coincides with the perpendicular bisector C-C′ of the hypothetical isosceles triangle A₁-A₂-A₃ having straight edges A₁-A₂, A₁-A₃, A₂-A₃ defined by the vertices A₁, A₂, A₃ on the hypothetical isosceles triangle defined by the cross section of the end cap 3. In another embodiment, the cross section of the end cap violates reflectional symmetry. The perpendicular bisector of the hypothetical isosceles triangle having edges curved outwards defined by the cross section of the end cap diverges from the perpendicular bisector of the hypothetical isosceles triangle having straight edges defined by vertices of the hypothetical isosceles triangle defined by the cross section of the end cap. The LED light strip 2 defines a hypothetical plane. In the embodiment in FIG. 24, the hypothetical plane meets the perpendicular bisector C-C′ of the hypothetical isosceles triangle defined by the cross section of the end cap 3 at a right angle. In another embodiment, the hypothetical plane meets the perpendicular bisector of the hypothetical isosceles triangle defined by the cross section of the end cap at a non-right angle.

Still on FIG. 24, the plane figures defined by the curved pair of legs 401, 401 on the hypothetical isosceles triangle defined by the cross section of the end cap 3 and a straight pair of legs A₁-A₂, A₁-A₃, A₂-A₃ on the hypothetical isosceles triangle A₁-A₂-A₃ defined by the vertices A₁, A₂, A₃ on the hypothetical isosceles triangle defined by the cross section of the end cap 3 encompass an area j (j/2+j/2). The plane figure defined by the curved base 402 on the hypothetical isosceles triangle defined by the cross section of the end cap 3 and the straight base A₂-A₃ on the hypothetical isosceles triangle A₁-A₂-A₃ defined by the vertices A₁, A₂, A₃ on the hypothetical isosceles triangle defined by the cross section of the end cap 3 encompasses an area k. In an embodiment, j is equal to 2k. In another embodiment, j is greater than 2k. In an embodiment, the ratio j/k is from 2.1 to 4. In the embodiment in FIG. 24, j is less than 2k. In an embodiment, the ratio j/k is from 0.33 to 1.95.

Still on FIG. 24, fillets on points of expected high stress—e.g. vertices A₁, A₂, A₃ on the cross section of the end cap 3—reduce stress concentration because the fillets distribute the stress over a broader area and make the LED tube lamp more durable and capable of withstanding rough handling. In an embodiment, a fillet is configured on a vertex on the cross section of the end cap. In the embodiment in FIG. 24, a fillet is configured on all vertices A₁, A₂, A₃ on the cross section of the end cap 3. In an embodiment, a fillet is configured on an interior corner of the vertex on the cross section of the end cap. In another embodiment, a fillet is configured on an exterior corner of the vertex on the cross section of the end cap. In the embodiment in FIG. 24, a first fillet is configured on an interior corner of a vertex A₁ (or A₂, A₃) on the cross section of the end cap 3. A second fillet is configured on an exterior corner of the vertex A₁ (or A₂, A₃) on the cross section of the end cap 3. The first fillet and the second fillet are spaced apart by a fixed normal distance. In the embodiment in FIG. 24, the fixed normal distance equals a thickness of the end cap 3. In another embodiment, the fixed normal distance is greater than the thickness of the end cap. In yet another embodiment, the fixed normal distance is less than the thickness of the end cap. In an embodiment, the fixed normal distance equals the thickness of the lamp tube 1. In another embodiment, the fixed normal distance is greater than the thickness of the lamp tube 1. In yet another embodiment, the fixed normal distance is less than the thickness of the lamp tube 1.

Still on FIG. 24, in an embodiment, the hypothetical isosceles triangle (enclosed by three curved edges 391, 391, 392) defined by the cross section of the lamp tube 1 and the hypothetical isosceles triangle (enclosed by three curved edges 401, 401, 402) defined by the cross section of the end cap 3 are parallel curves. In the embodiment in FIG. 24, the hypothetical isosceles triangle defined by the cross section of the end cap 3 encompasses the hypothetical isosceles triangle defined by the cross section of the lamp tube 1. In another embedment, the hypothetical isosceles triangle defined by the cross section of the lamp tube encompasses the hypothetical isosceles triangle defined by the cross section of the lamp tube. In yet another embedment, the hypothetical isosceles triangle defined by the cross section of the lamp tube coincides with the hypothetical isosceles triangle defined by the cross section of the end cap. In the embodiment in FIG. 24, the leg 401 of length e on the hypothetical isosceles triangle defined by the cross section of the end cap 3 is greater than the base 402 of length f on the hypothetical isosceles triangle defined by the cross section of the end cap 3. In an embodiment, the ratio e/f is from 1.05 to 1.5. Alternatively, the leg of length e on the hypothetical isosceles triangle defined by the cross section of the end cap 3 is less than the base of length f on the hypothetical isosceles triangle defined by the cross section of the end cap 3. In an embodiment, the ratio e/f is from 0.75 to 0.95.

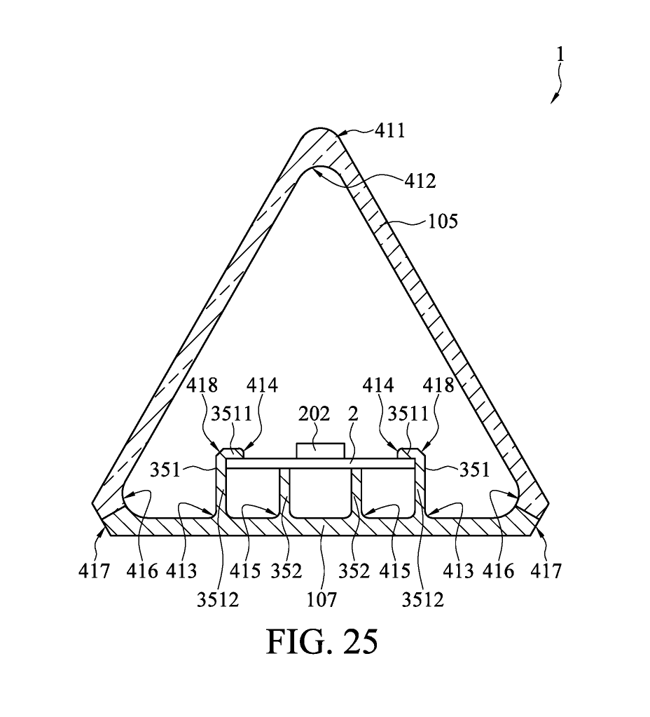

Shifting to FIG. 25, in accordance with an exemplary embodiment of the invention, a transitional edge is added between two faces of an object in the LED tube lamp to ease otherwise sharp edges both for human safety and to prevent damage to the LED tube lamp when the lamp is handled. Stress concentration is reduced because the transitional edge distributes the stress over a broader area and effectively made the parts more durable and capable of withstanding rough handling. The transitional edge is either a fillet, a chamfer or both. A fillet is a rounding of an interior corner or an exterior corner of an object. In the embodiment in FIG. 25, a fillet is configured on a corner of the lamp tube 1. In some embodiments, the fillet 411 is configured on an exterior corner of the lamp tube 1. In other embodiments (FIGS. 2, 4, 5 and 6), the fillet is configured on an interior corner of the lamp tube 1. In the embodiment in FIG. 25, a first fillet 412 is configured on the interior corner of the lamp tube 1. A second fillet 411 is configured on the exterior corner of the lamp tube 1 opposite the first fillet 412 on the interior corner of the lamp tube 1. The first fillet 412 and the second fillet 411 are spaced apart by a fixed normal distance. In an embodiment, the fixed normal distance equals the thickness of the lamp tube adjacent to the filleted corner. In another embodiment, the curvature of the first fillet on the interior corner of the lamp tube is greater than that of the second fillet on the exterior corner opposite the first fillet on the interior corner of the lamp tube. In the embodiment in FIG. 25, the curvature of the first fillet 412 on the interior corner of the lamp tube 1 is less than that of the second fillet 411 on the exterior corner of the lamp tube 1 opposite the first fillet 412 on the interior corner of the lamp tube 1. In an embodiment, the fillet 411, 412 is configured on a corner of the light transmissive portion 105. In other embodiments (FIGS. 2, 4, 5 and 6), the fillet is configured on a corner of the reinforcing portion 107. A fillet, for example, is configured on a corner of the bracing structure 351. A fillet 413 is configured on a corner of the vertical rib 3512. A fillet 414 is configured on a corner of the horizontal rib 3511. A fillet is configured on a corner of the curvilinear rib. A fillet 415 is configured on a corner of the protruding part 352. A fillet is configured on a corner of the platform. In yet another embodiment, a fillet is configured on a corner at which two structures of the LED tube lamp meet each other. A fillet 416 is configured, for example, on an interior corner at which the light transmissive portion 105 meets the reinforcing portion 107. A fillet is configured on a corner at which the vertical rib meets one of the horizontal rib, the curvilinear rib and the platform. A fillet is configured on a corner at which the horizontal rib meets one of the vertical rib, the curvilinear rib and the platform. A fillet is configured on a corner at which the curvilinear rib meets one of the vertical rib, the horizontal rib and the platform. A fillet is configured on a corner at which the platform meets one of the vertical rib, the horizontal rib and the curvilinear rib. In still another embodiment, a fillet is configured on a corner of the end cap. In an embodiment, a first fillet is configured on an interior corner of the end cap. A second fillet is configured on an exterior corner of the end cap opposite the first fillet on the interior corner of the end cap. The first fillet and the second fillet are spaced apart by a fixed normal distance. In another embodiment, the fixed normal distance equals the thickness of the end cap adjacent to the filleted corner. In yet another embodiment, the curvature of the first fillet is greater than that of the second fillet. In still another embodiment, the curvature of the first fillet is less than that of the second fillet. In some embodiments, a fillet is configured on a corner of the ridge. In other embodiments, a fillet is configured on a corner of the maintaining stick.

Still on FIG. 25, a chamfer is a form of bevel created at an angle (e.g. 45°) to two adjoining faces. In the embodiment in FIG. 25, a chamfer 417 configured on a corner of the lamp tube 1. In some embodiments, the chamfer 417 is configured on an exterior corner of the lamp tube 1. In other embodiments, the chamfer is configured on an interior corner of the lamp tube. In an embodiment, a first chamfer is configured on the interior corner of the lamp tube. A second chamfer is configured on the exterior corner of the lamp tube opposite the first chamfer on the interior corner of the lamp tube. The first chamfer and the second chamfer are spaced apart by a fixed normal distance. In an embodiment, the fixed normal distance equals the thickness of the lamp tube adjacent to the chamfered corner. In another embodiment, the chamfer is configured on a corner of the light transmissive portion. In yet another embodiment, the chamfer 418 is configured on a corner of the reinforcing portion 107. A chamfer 418, for example, is configured on a corner of the bracing structure 351. A chamfer is configured on a corner of the vertical rib. A chamfer is configured on a corner of the horizontal rib. A chamfer is configured on a corner of the curvilinear rib. A chamfer is configured on a corner of the protruding part. A chamfer is configured on a corner of the platform. In yet another embodiment, a chamfer is configured on a corner at which two structures of the LED tube lamp meet each other. A chamfer 417 is configured, for example, on an exterior corner at which the light transmissive portion 105 meets the reinforcing portion 107. A chamfer 418 is configured on a corner at which the vertical rib 3512 meets the horizontal rib 3511. In an embodiment, a chamfer is configured on a corner at which the vertical rib meets one of the curvilinear rib and the platform. A chamfer is configured on a corner at which the horizontal rib meets one of the vertical rib, the curvilinear rib and the platform. A chamfer is configured on a corner at which the curvilinear rib meets one of the vertical rib, the horizontal rib and the platform. A chamfer is configured on a corner at which the platform meets one of the vertical rib, the horizontal rib and the curvilinear rib. In still another embodiment, a chamfer is configured on a corner of the end cap. In an embodiment, a first chamfer is configured on an interior corner of the end cap. A second chamfer is configured on an exterior corner of the end cap opposite the first chamfer on the interior corner of the end cap. The first chamfer and the second chamfer are spaced apart by a fixed normal distance. In another embodiment, the fixed normal distance equals the thickness of the end cap adjacent to the chamfered corner. In some embodiments, a chamfer is configured on a corner of the ridge. In other embodiments, a chamfer is configured on a corner of the maintaining stick.

A fluorescent tube lamp includes a lamp tube having, traditionally, a circular cross section for good reasons. The lamp tube is filled with a gas containing low-pressure mercury vapor and argon, xenon, neon or krypton. The pressure inside the lamp is around 0.3% of atmospheric pressure. The inner surface of the lamp is coated with a fluorescent (and often slightly phosphorescent) coating made of varying blends of metallic and rare-earth phosphor salts. The circular cross section provides the lamp tube with structural strength needed to overcome the weight of air on its surface outside the lamp tube. Other things equal, when a lamp tube provides a bigger inner surface to which fluorescent chemicals are coated, the lamp shines brighter. The lamp tube having a circular cross section is a sound option. Also, omnidirectional light makes a circular cross section a perfect solution for the lamp tube. An LED tube lamp, however, operates on an entirely different set of principles. Maximizing coating surface is no longer essential for luminous output. Air pressure on the lamp tube becomes irrelevant. Cylindrical lamp tubes, when used in LED tube lamps, induce potential inconvenience if not loss under certain unfortunate circumstances. An LED tube lamp, whose light is inherently directional, must be correctly oriented before plugging into a light fixture. Cylindrical lamp tubes, unless otherwise pointed out, reveals little visual indication of their correct orientation. Moreover, cylindrical lamp tubes roll off the desk easily. Thus, LED luminaries open up whole new possibilities for engineering the shape of the lamp tube.

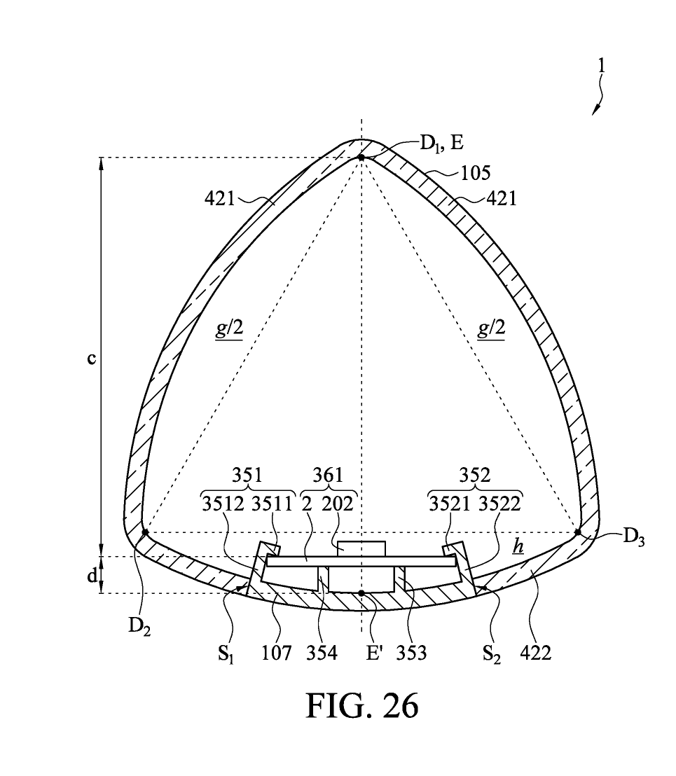

Turning to FIG. 26, a curve of constant width is a convex planar shape whose width remains the same regardless of its orientation. An LED lamp tube having a cross section defining a curve of constant width provides advantages otherwise unavailable. The package—usually having a square cross section—designed for conventional cylindrical tube lamps having a circular cross section (which is also a curve of constant width having a diameter D; FIGS. 1, 6-17 and 34) is suitable for tube lamps having a cross section defining any type of curve of constant width whose width W is the same as the diameter D. Likewise, the lighting fixture or the troffer designed for conventional cylindrical lamp tubes is suitable for tube lamps having a cross section defining any type of curve of constant width having the same width. Unlike a cylindrical lamp tube that generates a same luminous field because the lamp tube looks the same when rotating around its longitudinal axis in a lighting fixture, a lamp tube having a cross section defining a curve of constant width other than a circle generates different luminous fields by adjusting its orientation in the lighting fixture. A circle has the maximum area of any curve of constant width. The LED lamp tube is configured to have a cross section defining any curve of constant width other than a circle when a trimmed profile of the lamp tube is desirable.

Staying on FIG. 26, in some embodiments, the lamp tube 1 has a cross section defining a curve of constant width. In other embodiments, the end cap has a cross section defining a curve of constant width. In the embodiment in FIG. 26, the curve of constant width is the boundary of a Reuleaux triangle enclosed by three circular arcs 421, 421, 422. Alternatively, the curve of constant width is an n-sided curve of constant width based on any polygon having an odd number of sides. Alternatively, the curve of constant width is an irregular shape of constant width. In an embodiment, either the lamp tube or the end cap but not both has a cross section defining a curve of constant width. In some embodiments, the first curve of constant width defined by the cross section of the lamp tube and the second curve of constant width defined by the cross section of the end cap are parallel curves. The first curve of constant width encompasses the second curve of constant width. Alternatively, the second curve of constant width encompasses the first curve of constant width. In other embodiments, the first curve of constant width and the second curve of constant width are not parallel curves. In an embodiment, either the inner surface or the outer surface of the lamp tube but not both defines a curve of constant width. In the embodiment in FIG. 26, the first curve of constant width defined by the cross section of the inner surface of the lamp tube 1 and the second curve of constant width defined by the cross section of the outer surface of the lamp tube 1 are parallel curves. In other embodiments, the first curve of constant width and the second curve of constant width are not parallel curves. In an embodiment, either the cross section of the inner surface of the end cap or the cross section of the outer surface of the end cap but not both defines a curve of constant width. In some embodiments, the first curve of constant width defined by the cross section of the inner surface of the end cap and the second curve of constant width defined by the cross section of the outer surface of the end cap are parallel curves. In other embodiments, the first curve of constant width and the second curve of constant width are not parallel curves.

Still on FIG. 26, in an embodiment, vertices D₁, D₂, D₃ on the hypothetical Reuleaux triangle define a hypothetical isosceles triangle D₁-D₂-D₃ having a straight base D₂-D₃ and a straight pair of legs D₁-D₂, D₁-D₃. The hypothetical Reuleaux triangle is enclosed by a symmetric pair of circular arcs 421, 421 having a same radius R₁ and a same length L₁ and by a third circular arc 422 having a radius R₂ and a length L₂. In an embodiment, the third circular arc and the pair of circular arcs have a same length (L₁=L₂) or a same radius (R₁=R₂) but not both. In another embodiment, the third circular arc and the pair of circular arcs have both a same length (L₁=L₂) and a same radius (R₁=R₂). In the embodiment in FIG. 26, the third circular arc 422 and the pair of circular arcs 421, 421 have different lengths (L₁≠L₂) and different radii (R₁≠R₂). In the embodiment in FIG. 26, L₁>L₂ and R₁>R₂. In an embodiment, the ratio L₁/L₂ is from 1.05 to 1.5; the ratio R₁/R₂ is from 1.05 to 1.2. In another embodiment, L₁<L₂ and R₁<R₂. In an embodiment, the ratio L₁/L₂ is from 0.75 to 0.95; the ratio R₁/R₂ is from 0.8 to 0.95. In yet another embodiment, L₁>L₂ but R₁<R₂. In an embodiment, the ratio L₁/L₂ is from 1.05 to 1.5; the ratio R₁/R₂ is from 0.8 to 0.95. In still another embodiment, L₁<L₂ but R₁>R₂. In an embodiment, the ratio L₁/L₂ is from 0.75 to 0.95; the ratio R₁/R₂ is from 1.05 to 1.2.

Still on FIG. 26, the lamp tube 1 defines the hypothetical Reuleaux triangle in a variety of ways. In a first embodiment, the bottom edge of the cross section of the reinforcing portion defines a first one of the symmetrical pair of circular arcs on the Reuleaux triangle. In an embodiment, the bottom edge of the cross section of the reinforcing portion defines a first portion of the first one of the symmetrical pair of circular arcs on the Reuleaux triangle. In another embodiment, the first portion of the first one of the symmetrical pair of circular arcs on the Reuleaux triangle is a middle portion on the first one of the symmetrical pair of circular arcs on the Reuleaux triangle. The cross section of the light transmissive portion defines a right portion of the first one of the symmetrical pair of circular arcs on the Reuleaux triangle; a left portion of the first one of the symmetrical pair of circular arcs on the Reuleaux triangle; a second one of the symmetrical pair of circular arcs on the Reuleaux triangle; and the third circular arc on the Reuleaux triangle. In an embodiment, the third circular arc on the Reuleaux triangle is defined exclusively by the bottom edge of the cross section of the reinforcing portion. In the embodiment in FIG. 26, the bottom edge of the cross section of the reinforcing portion 107 defines a first portion of the third circular arc 422 on the Reuleaux triangle. In another embodiment, the first portion of the third circular arc 422 on the Reuleaux triangle is a middle portion on the third circular arc 422 on the Reuleaux triangle. The cross section of the light transmissive portion 105 defines a right portion of the third circular arc 422 on the Reuleaux triangle; a left portion of the third circular arc 422 on the Reuleaux triangle; and the symmetrical pair of circular arcs 421, 421 on the Reuleaux triangle. The ratio of the width of the LED light strip 2 to the length of the straight base D₂-D₃ on the hypothetical isosceles triangle D₁-D₂-D₃ defined by the vertices D₁, D₂, D₃ on the hypothetical Reuleaux triangle is R. In an embodiment, R is from 0.3 to 0.9. In another embodiment, R is from 0.6 to 0.8.

Still on FIG. 26, the light transmissive portion 105 is fixedly connected to the reinforcing portion 107 on the lamp tube 1 configured as a monolithic structure. The reinforcing portion 107 includes a plurality of bracing structures 351, 352 at endpoints S₁, S₂ on the reinforcing portion 107 and a plurality of protruding parts 353, 354 spaced apart between the endpoints S₁, S₂ on the reinforcing portion 107. The bracing structure 351, 352 includes a combination of vertical ribs 3512, 3522 and horizontal ribs 3511, 3521. The LED light strip 2—which defines a hypothetical horizontal line on the cross section of the lamp tube 1—abuts against the bracing structure 351, 322 to stay in place in the lamp tube 1. The LED light assembly 361 receives upright support from the plurality of protruding parts 353, 354. In the embodiment in FIG. 26, the reinforcing portion 107 includes a pair of bracing structures 351, 352 and a pair of protruding parts 353, 354 between the pair of bracing structures 351, 352. The pair of bracing structures 351, 352 includes a left vertical rib 3512 on the left bracing structure 351, a left horizontal rib 3511 on the left bracing structure 351, a right vertical rib 3522 on the right bracing structure 352 and a right horizontal rib 3521 on the right bracing structure 352. The left vertical rib 3512 having a first left base extends upwards from S₁ at which the light transmissive portion 105 and the reinforcing portion 107 merge. The left horizontal rib 3511 merges with the left vertical rib 3512 at a point slightly higher than an upper surface of the LED light strip 2. The right vertical rib 3522 having a first right base extends upwards from S₂ at which the light transmissive portion 105 and the reinforcing portion 107 merge. The right horizontal rib 3521 merges with the right vertical rib 3522 at a point slightly higher than the upper surface of the LED light strip 2. In the embodiment in FIG. 26, the left vertical rib 3512 leans slightly inwards towards the left edge of the LED light strip 2. Similarly, the right vertical rib 3522 leans slightly inwards towards the right edge of the LED light strip 2. In another embodiment, the vertical rib extends upwards exactly along a same direction of the hypocritical line bisecting the lamp tube. In yet another embodiment, the vertical rib extends upwards exactly along a same direction of a normal line to a circular arc at the base of the vertical rib on the hypothetical Reuleaux triangle defined by the reinforcing portion. In the embodiment in FIG. 26, the left horizontal rib 3511 angles slightly downwards towards the upper surface of the LED light strip 2. Likewise, the right horizontal rib 3521 angles slightly downwards towards the upper surface of the LED light strip 2. In another embodiment, the horizontal rib extends inwards towards the LED light assembly exactly along a same direction of the hypothetical line defined by the cross section of the LED light strip. In the embodiment in FIG. 26, the left protruding part 354 having a second left base erects from a point closer to S₁ than S₂ between S₁ and S₂ on the reinforcing portion 107 towards a lower surface of the LED light strip 2. The right protruding part 353 having a second right base erects from a point closer to S₂ than S₁ between S₁ and S₂ on the reinforcing portion 107 towards the lower surface of the LED light strip 2. In the embodiment in FIG. 26, the protruding part 353, 354 erects exactly along a same direction of the hypothetical line bisecting the cross section of the lamp tube 1. In another embodiment, the protruding part erects exactly along a same direction of a normal line to a circular arc at the base of the protruding part on the hypothetical Reuleaux triangle defined by the reinforcing portion. In the embodiment in FIG. 26, friction arising from interfaces among a surface of the LED light strip 2, the bracing structure 351, 352 and the protruding part 353, 354 fixes the LED light assembly 361 in place in the lamp tube 1. The friction can be overcome by a lateral force upon the LED light strip 2 without damaging the LED light assembly 361. The LED light assembly 361 is removable from the lamp tube 1 with a non-destructive force. In another embodiment, the friction cannot be overcome by the lateral force without damaging the LED light assembly.

Still on FIG. 26, in an embodiment, the cross section of the lamp tube 1 has reflectional symmetry. The perpendicular bisector E-E′ of the hypothetical Reuleaux triangle defined by the cross section of the lamp tube 1 coincides with the perpendicular bisector E-E′ of the hypothetical isosceles triangle D₁-D₂-D₃ having straight edges D₁-D₂, D₁-D₃, D₂-D₃ defined by vertices V₁, V₂, V₃ of the hypothetical Reuleaux triangle defined by the cross section of the lamp tube 1. In another embodiment, the cross section of the lamp tube violates reflectional symmetry. The perpendicular bisector of the hypothetical Reuleaux triangle defined by the cross section of the lamp tube diverges from a perpendicular bisector of the hypothetical isosceles triangle having straight edges defined by vertices of the hypothetical Reuleaux triangle defined by the cross section of the lamp tube. The cross section of the LED light strip 2 defines a hypothetical line. In the embodiment in FIG. 26, the hypothetical line meets the perpendicular bisector E-E′ of the hypothetical Reuleaux triangle defined by the cross section of the lamp tube at a right angle. In another embodiment, the hypothetical line meets the perpendicular bisector of the hypothetical Reuleaux triangle defined by the cross section of the lamp tube at a non-right angle.

Still on FIG. 26, the higher the LED light assembly 361 finds itself in the lamp tube 1, the greater the space is underneath the LED light assembly 361 for airflow to carry heat away from the LED light source 202. By contrast, the lower the LED light assembly 361 finds itself in the lamp tube 1, the wider the field angle is illuminated by the LED tube lamp—other things equal—at the expense of heatsinking efficiency. A perpendicular bisector E-E′ of the hypothetical Reuleaux triangle defined by the cross section of the lamp tube 1 is divided by the hypothetical curve defined by the cross section of the inner surface of the lamp tube 1 and the hypothetical line defined by the cross section of the upper surface of the LED light strip 2 into an upper segment of length c and a lower segment of length d. In the embodiment in FIG. 26, the upper segment of length c is greater than the lower segment of length d. The ratio d/c is from 5 to 15. In another embodiment, the upper segment of length c is less than the lower segment of length d. The ratio d/c is from 0.4 to 0.9. In yet another embodiment, the upper segment of length c is equal to the lower segment of length d.

Sill on FIG. 26, the higher the LED light assembly 361 finds itself in the lamp tube 1, the greater the space is underneath the LED light assembly 361 for airflow to carry moving heat away from the LED light assembly 361. By contrast, the lower the LED light assembly 361 finds itself in the lamp tube 1, the wider the field angle is illuminated by the LED tube lamp—other things equal—at the expense of heatsinking efficiency. In an embodiment, the hypothetical line defined by the cross section of the LED light strip coincides with the straight base D₂-D₃ on the hypothetical isosceles triangle D₁-D₂-D₃ defined by the vertices D₁, D₂, D₃ on the hypothetical Reuleaux triangle defined by the cross section of the lamp tube. In another embodiment, the hypothetical line defined by the cross section of the LED light strip rises above the straight base D₂-D₃ on the hypothetical isosceles triangle D₁-D₂-D₃ defined by the vertices D₁, D₂, D₃ on the hypothetical Reuleaux triangle defined by the cross section of the lamp tube. In the embodiment in FIG. 26, the hypothetical line defined by the cross section of the LED light strip 2 sits below the straight base D₂-D₃ on the hypothetical isosceles triangle D₁-D₂-D₃ defined by the vertices D₁, D₂, D₃ on the hypothetical Reuleaux triangle defined by the cross section of the lamp tube 1.

Still on FIG. 26, plane figures defined by the symmetric pair of circular arcs 421, 421 on the hypothetical Reuleaux triangle defined by the cross section of the lamp tube 1 and the straight pair of legs D₁-D₂, D₁-D₃ on the hypothetical isosceles triangle D₁-D₂-D₃ defined by the vertices D₁, D₂, D₃ on the hypothetical Reuleaux triangle defined by the cross section of the lamp tube 1 encompass an area g. A plane figure defined by the third circular arc 422 on the hypothetical Reuleaux triangle defined by the cross section of the lamp tube 1 and the straight base D₂-D₃ of the hypothetical isosceles triangle D₁-D₂-D₃ defined by the vertices D₁, D₂, D₃ on the hypothetical Reuleaux triangle defined by the cross section of the lamp tube 1 encompasses an area h. In an embodiment, g is equal to 2h. In another embodiment, g is greater than 2h. The ratio g/h is from 2.1 to 4. In yet another embodiment, g is less than 2h. The ratio g/h is from 0.33 to 1.95.

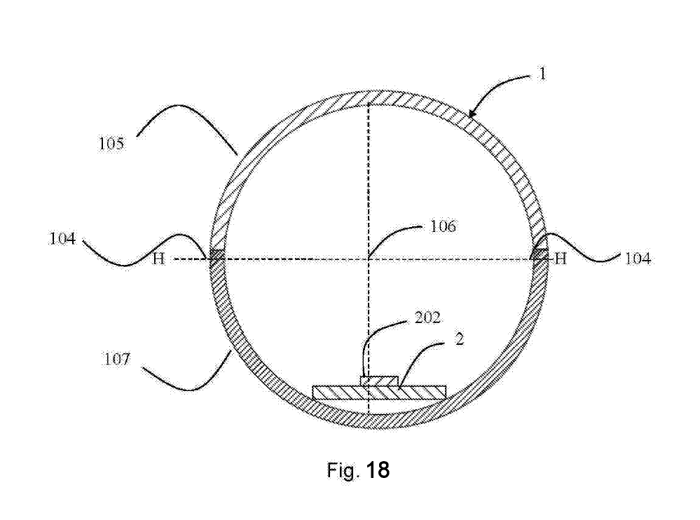

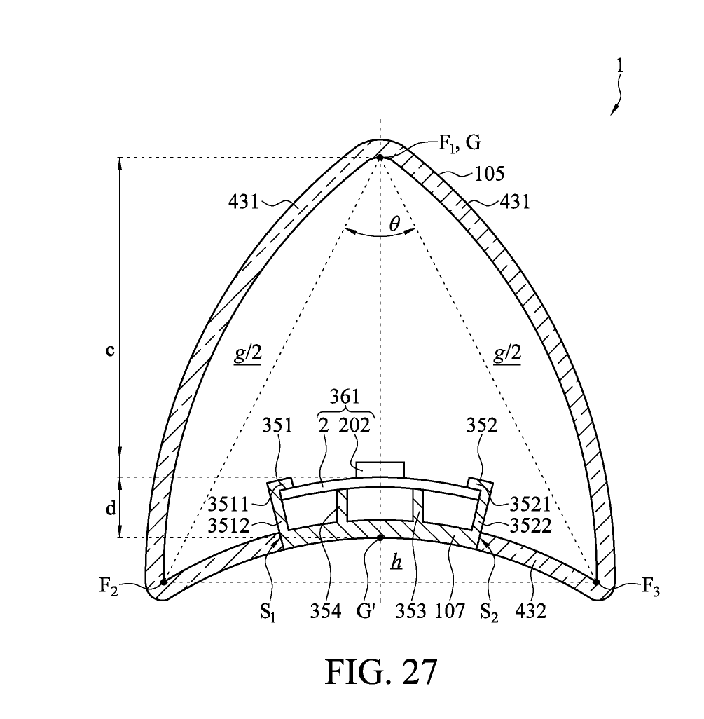

Turning to FIG. 27, in some embodiments, the lamp tube 1 has a cross section defining a hypothetical curve constructed by a plurality of hypothetical circles intersecting one another. In other embodiments, the end cap has a cross section defining a hypothetical curve constructed by a plurality of hypothetical circles intersecting one another. In FIGS. 1, 6-17 and 18-19, the cross section of the lamp tube 1 defines a hypothetical circle when a set of three hypothetical circles coincide. In the embodiment in FIG. 27, the cross section of the lamp tube 1 defines a hypothetical circular triangle having a trio of circular arc edges 431, 431, 432. In the embodiment in FIG. 26, the cross section of the lamp tube 1 defines a hypothetical circular triangle enclosed by three convex arc edges 421, 421, 422. In another embodiment, the cross section of the lamp tube defines a hypothetical circular triangle enclosed by three concave arc edges. In the embodiment in FIG. 27, the cross section of the lamp tube 1 defines a hypothetical circular triangle enclosed by a pair of convex arc edges 431, 431 and a concave arc edge 432. In an embodiment, either the lamp tube or the end cap but not both has a cross section defining a hypothetical circular triangle. In some embodiments, the first hypothetical circular triangle defined by the cross section of the lamp tube and the second hypothetical circular triangle defined by the end cap are parallel curves. The first hypothetical circular triangle encompasses the second hypothetical circular triangle. Alternatively, the second hypothetical circular triangle encompasses the first hypothetical circular triangle. In other embodiments, the first hypothetical circular triangle and the second hypothetical circular triangle are not parallel curves. In an embodiment, either the inner surface or the outer surface of the lamp tube but not both defines a hypothetical circular triangle. In the embodiment in FIG. 27, the first hypothetical circular triangle defined by the inner surface of the lamp tube 1 and the second hypothetical circular triangle defined by the outer surface of the lamp tube 1 are parallel curves. In other embodiments, the first hypothetical circular triangle and the second hypothetical circular triangle are not parallel curves. In an embodiment, either the inner surface or the outer surface of the end cap but not both defines a hypothetical circular triangle. In some embodiments, the first hypothetical circular triangle defined by the inner surface of the end cap and the second hypothetical circular triangle defined by the outer surface of the end cap are parallel curves. In other embodiments, the first hypothetical circular triangle and the second hypothetical circular triangle are not parallel curves.

Staying on FIG. 27, in an embodiment, vertices F₁, F₂, F₃ on the hypothetical circular triangle define a hypothetical isosceles triangle F₁-F₂-F₃ having a straight base F₂-F₃ and a straight pair of legs F₁-F₂, F₁-F₃. The hypothetical circular triangle is enclosed by a symmetric pair of convex arc edges 431, 431 having a same radius R₁ and a same length L₁ and by a concave arc edge 432 having a radius R₂ and a length L₂. In an embodiment, the concave arc edge and the pair of convex arc edges have a same length (L₁=L₂) or a same radius (R₁=R₂) but not both. In another embodiment, the concave arc edge and the pair of convex arc edges have both a same length (L₁=L₂) and a same radius (R₁=R₂). In the embodiment in FIG. 27, the concave arc edge 432 and the pair of convex arc edges 431, 431 have different lengths (L₁≠L₂) and different radii (R₁≠R₂). In the embodiment in FIG. 27, L₁>L₂ and R₁>R₂. In an embodiment, the ratio L₁/L₂ is from 1.05 to 1.5; the ratio R₁/R₂ is from 1.05 to 1.2. In another embodiment, L₁<L₂ and R₁<R₂. In an embodiment, the ratio L₁/L₂ is from 0.75 to 0.95; the ratio R₁/R₂ is from 0.8 to 0.95. In yet another embodiment, L₁>L₂ but R₁<R₂. In still another embodiment, L₁<L₂ but R₁>R₂. In an embodiment, the ratio L₁/L₂ is from 0.75 to 0.95; the ratio R₁/R₂ is from 1.05 to 1.2.

Still on FIG. 27, the lamp tube 1 defines the hypothetical circular triangle in a variety of ways. In an embodiment, a first one of the pair of convex arc edges on the hypothetical circular triangle defined by the cross section of the lamp tube is defined exclusively by the bottom edge of the cross section of the reinforcing portion. In another embodiment, the bottom edge of the cross section of the reinforcing portion defines a first portion of the first one of the pair of convex arc edges on the hypothetical circular triangle defined by the cross section of the lamp tube. In yet another embodiment, the first portion of the first one of the pair of convex arc edges on the hypothetical circular triangle defined by the cross section of the lamp tube is a middle portion on the first one of the pair of convex arc edges on the hypothetical circular triangle defined by the cross section of the lamp tube. The cross section of the light transmissive portion defines a right portion of the first one of the pair of convex arc edges on the hypothetical circular triangle defined by the cross section of the lamp tube; a left portion of the first one of the pair of convex arc edges on the hypothetical circular triangle defined by the cross section of the lamp tube; a second one of the pair of convex arc edges on the hypothetical circular triangle defined by the cross section of the lamp tube; and the concave arc edge on the hypothetical circular triangle defined by the cross section of the lamp tube. In an embodiment, the concave arc edge on the hypothetical circular triangle defined by the cross section of the lamp tube is defined exclusively by the bottom edge of a cross section of the reinforcing portion. In another embodiment, the bottom edge of the cross section of the reinforcing portion 107 defines a first portion of the convex arc edge 432 on the hypothetical circular triangle defined by the cross section of the lamp tube. In yet another embodiment, the first portion of the concave arc edge 432 on the hypothetical circular triangle is a middle portion on the concave arc edge 432 on the hypothetical circular triangle defined by the cross section of the lamp tube 1. The cross section of the light transmissive portion 105 defines a right portion of the concave arc edge 432 on the hypothetical circular triangle defined by the cross section of the lamp tube 1; a left portion of the concave arc edge 432 on the hypothetical circular triangle defined by the cross section of the lamp tube 1; and the pair of convex arc edges 431, 431 on the hypothetical circular triangle defined by the cross section of the lamp tube 1. The ratio of the width of the LED light strip 2 along a horizontal axis to the length of the straight base F₂-F₃ on the hypothetical isosceles triangle F₁-F₂-F₃ defined by the vertices F₁, F₂, F₃ on the hypothetical circular triangle defined by the cross section of the lamp tube 1 is R. In an embodiment, R is from 0.3 to 0.9. In another embodiment, R is from 0.6 to 0.8. Angle θ is defined by the pair of straight legs F₁-F₂, F₁-F₃ on the hypothetical isosceles triangle F₁-F₂-F₃ defined by the vertices F₁, F₂, F₃ on the hypothetical circular triangle defined by the cross section of the lamp tube 1. In an embodiment, θ is from 30 to 60. T is a ratio of the length of the leg F₁-F₂, F₁-F₃ on the hypothetical isosceles triangle F₁-F₂-F₃ defined by the vertices F₁, F₂, F₃ on the hypothetical circular triangle defined by the cross section of the lamp tube 1 to the length of the base F₂-F₃ on the hypothetical isosceles triangle F₁-F₂-F₃ defined by the vertices F₁, F₂, F₃ on the hypothetical circular triangle defined by the cross section of the lamp tube 1. In an embodiment, T is from 0.75 to 1.5.

In an embodiment, the LED light strip is made from a flexible material. Staying on FIG. 27, in an embodiment, the cross section of the LED light assembly 361 defines a hypothetical curve in the lamp tube 1. In an embodiment, the LED light strip displays a self-sustained curve on the cross section of the lamp tube when permanent changes occur within the material of the LED light strip. In another embodiment, the LED light strip is bent into a curve on the cross section of the lamp tube only when an external force is applied upon the LED light strip. The external force comes from the bracing structure, the protruding part or both. In the embodiment in FIG. 27, the hypothetical curve defined by the cross section of the LED light strip 2 runs parallel with the concave arc edge 432 defined by the hypothetical circular triangle defined by the cross section of the lamp tube 1. In an embodiment, the LED light strip stretches beyond the space defined by the straight pair of legs F₁-F₂, F₁-F₃ on the hypothetical isosceles triangle F₁-F₂-F₃ defined by the vertices F₁, F₂, F₃ on the hypothetical circular triangle defined by the cross section of the lamp tube. In the embodiment in FIG. 27, the LED light strip 2 stays within the space defined by the straight pair of legs F₁-F₂, F₁-F₃ on the hypothetical isosceles triangle F₁-F₂-F₃ defined by the vertices F₁, F₂, F₃ on the hypothetical circular triangle defined by the cross section of the lamp tube 1.

Still on FIG. 27, the light transmissive portion 105 is fixedly connected to the reinforcing portion 107 on the lamp tube 1 configured as a monolithic structure. The reinforcing portion 107 includes a plurality of bracing structures 351, 352 at the endpoints S₁, S₂ of the reinforcing portion 107 and a plurality of protruding parts 353, 354 spaced apart between the endpoints S₁, S₂ of the reinforcing portion 107. The bracing structure 351, 352 includes a combination of vertical ribs 3512, 3522 and horizontal ribs 3511, 3521. The LED light strip 2 abuts against the bracing structure 351, 322 to stay in place—and possibly stay in shape—in the lamp tube 1. The LED light assembly 361 receives upright support from the plurality of protruding parts 353, 354. In the embodiment in FIG. 27, the reinforcing portion 107 includes a pair of bracing structures 351, 352 and a pair of protruding parts 353, 354. The pair of bracing structures 351, 352 includes a left vertical rib 3512 on the left bracing structure 351, a left horizontal rib 3511 on the left bracing structure 351, a right vertical rib 3522 on the right bracing structure 352 and a right horizontal rib 3521 on the right bracing structure 352. The left vertical rib 3512 having a first left base extends upwards from S₁ at which the light transmissive portion 105 and the reinforcing portion 107 merge. The left horizontal rib 3511 merges with the left vertical rib 3512 at a point slightly higher than the left edge of the upper surface of the LED light strip 2. The right vertical rib 3522 having a first right base extends upwards from S₂ at which the light transmissive portion 105 and the reinforcing portion 107 merge. The right horizontal rib 3521 merges with the right vertical rib 3522 at a point slightly higher than the right edge of the upper surface of the LED light strip 2. In the embodiment in FIG. 27, the left vertical rib 3512 inclines slightly outwards to abut the left edge of the LED light strip 2. Similarly, the right vertical rib 3522 inclines slightly outwards to abut the right edge of the LED light strip 2. In another embodiment, the vertical rib extends upwards exactly along a same direction of the hypocritical line bisecting the cross section of the lamp tube. In yet another embodiment, the vertical rib extends upwards exactly along a same direction of a normal line to an arc edge at the base of the vertical rib on the hypothetical circular triangle partially defined by the cross section of the reinforcing portion. In the embodiment in FIG. 27, the left horizontal rib 3511 angles slightly upwards to approximate the angle of the left edge of the upper surface of the LED light strip 2. Similarly, the right horizontal rib 3521 angles slightly upwards to approximate the angle of the right edge of the upper surface of the LED light strip 2. In another embodiment, the horizontal rib extends inwards towards the LED light assembly exactly along a direction perpendicular to the bisector of the cross section of the lamp tube. In the embodiment in FIG. 27, the left protruding part 354 having a second left base erects from a point closer to S₁ than S₂ between S₁ and S₂ on the reinforcing portion 107 towards a lower surface of the LED light strip 2. The right protruding part 353 having a second right base erects from a point closer to S₂ than S₁ between S₁ and S₂ on the reinforcing portion 107 towards the lower surface of the LED light strip 2. In the embodiment in FIG. 27, the protruding part 353, 354 erects exactly along a same direction of the hypothetical line bisecting the cross section of the lamp tube 1. In another embodiment, the protruding part erects exactly along a same direction of a normal line to an arc edge at the base of the protruding part on the hypothetical circular triangle partially defined by the reinforcing portion. In the embodiment in FIG. 27, friction arising from interfaces among a surface of the LED light strip 2, the bracing structure 351, 352 and the protruding part 353, 354 fixes the LED light assembly 361 in place—and possibly in shape—in the lamp tube 1. The friction can be overcome by a lateral force upon the LED light strip 2 without damaging the LED light assembly 361. The LED light assembly 361 is removable from the lamp tube 1 with the non-destructive force. In another embodiment, the friction cannot be overcome by the lateral force without damaging the LED light assembly.

Still on FIG. 27, in an embodiment, the cross section of the lamp tube 1 has reflectional symmetry. The perpendicular bisector G-G′ of the hypothetical circular triangle defined by the cross section of the lamp tube 1 coincides with the perpendicular bisector G-G′ of the hypothetical isosceles triangle F₁-F₂-F₃ having straight edges F₁-F₂, F₁-F₃, F₂-F₃ defined by the vertices F₁, F₂, F₃ of the hypothetical circular triangle defined by the cross section of the lamp tube 1. In another embodiment, the cross section of the lamp tube violates reflectional symmetry. The perpendicular bisector of the hypothetical circular triangle defined by the cross section of the lamp tube diverges from a perpendicular bisector of the hypothetical isosceles triangle having straight edges defined by the vertices of the hypothetical circular triangle defined by the cross section of the lamp tube.

Still on FIG. 27, the higher the LED light assembly 361 finds itself in the lamp tube 1, the greater the space is underneath the LED light assembly 361 for airflow to carry heat away from the LED light assembly 361. By contrast, the lower the LED light assembly 361 finds itself in the lamp tube 1, the wider the field angle is illuminated by the LED tube lamp—other things equal—at the expense of heatsinking efficiency. A perpendicular bisector G-G′ of hypothetical circular triangle defined by the cross section of the lamp tube 1 is divided by the hypothetical curve defined by the cross section of the inner surface of the lamp tube 1 and the hypothetical curve defined by the cross section of the upper surface the LED light strip 2 into an upper segment of length c and a lower segment of length d. In the embodiment in FIG. 27, the upper segment of length c is greater than the lower segment of length d. The ratio d/c is from 0.3 to 0.6. In another embodiment, the upper segment of length c is less than the lower segment of length d. The ratio d/c is from 4 to 8. In yet another embodiment, the upper segment of length c is equal to the lower segment of length d.

Still on FIG. 27, the higher the LED light assembly 361 finds itself in the lamp tube 1, the greater the space is underneath the LED light assembly 361 for airflow to carry heat away from the LED light assembly 361. On the other hand, the lower the LED light assembly 361 finds itself in the lamp tube 1, the wider the field angle is illuminated by the LED tube lamp—other things equal—at the expense of heatsinking efficiency. In an embodiment, the hypothetical curve defined by the cross section of the LED light strip coincides with the straight base F₂-F₃ on the hypothetical isosceles triangle F₁-F₂-F₃ defined by the vertices F₁, F₂, F₃ on the hypothetical circular triangle defined by the cross section of the lamp tube. In the embodiment in FIG. 27, the hypothetical curve defined by the cross section of the LED light strip 2 rises above the straight base F₂-F₃ on the hypothetical isosceles triangle F₁-F₂-F₃ defined by the vertices F₁, F₂, F₃ on the hypothetical circular triangle defined by the cross section of the lamp tube 1. In another embodiment, the hypothetical curve defined by the cross section of the LED light strip sits below the straight base F₂-F₃ on the hypothetical isosceles triangle F₁-F₂-F₃ defined by the vertices F₁, F₂, F₃ on the hypothetical circular triangle defined by the cross section of the lamp tube.

Still on FIG. 27, plane figures defined by the symmetric pair of convex arc edges 431, 431 on the hypothetical circular triangle defined by the cross section of the lamp tube 1 and the straight pair of legs F₁-F₂, F₁-F₃ on the hypothetical isosceles triangle F₁-F₂-F₃ defined by the vertices F₁, F₂, F₃ on the hypothetical circular triangle defined by the cross section of the lamp tube 1 encompass an area g. A plane figure defined by the concave arc edge 432 on the hypothetical circular triangle defined by the cross section of the lamp tube 1 and the straight base F₂-F₃ on the hypothetical isosceles triangle F₁-F₂-F₃ defined by the vertices F₁, F₂, F₃ on the hypothetical circular triangle defined by the cross section of the lamp tube 1 encompasses an area h. In an embodiment, g is equal to 2h. In another embodiment, g is greater than 2h. The ratio g/h is from 2.1 to 4. In yet another embodiment, g is less than 2h. The ratio g/h is from 0.33 to 1.95.

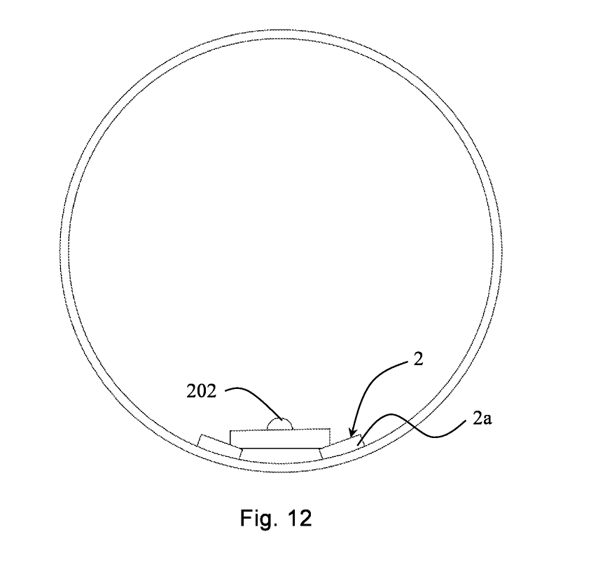

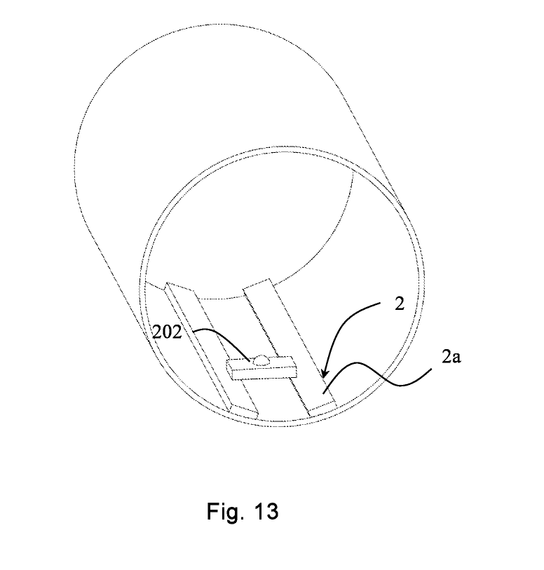

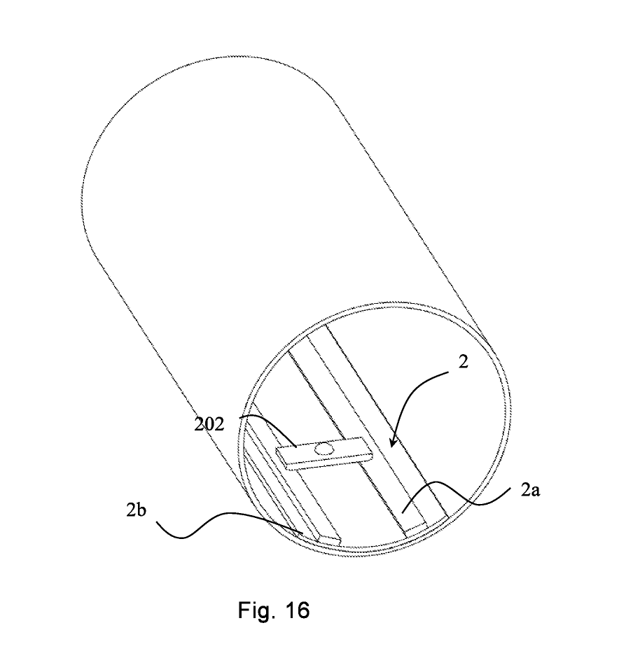

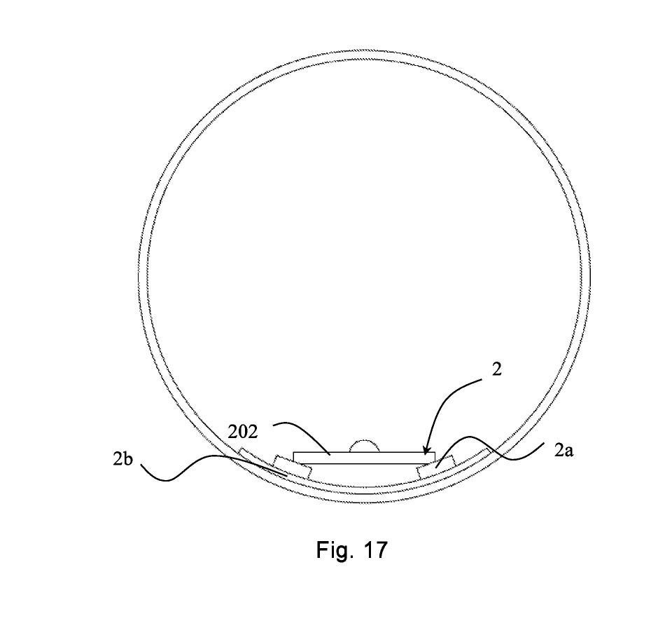

In an embodiment, the LED light strip is made from flexible substrate material. Referring to FIGS. 12 and 13, in accordance with an exemplary embodiment of the claimed invention, the flexible LED light strip 2 includes a wiring layer 2a. The wiring layer 2a is an electrically conductive layer (e.g. a metallic layer or a layer of copper wire) and is electrically connected to the power supply. The LED light source 202 is disposed on and electrically connected to a first surface of the wiring layer 2a. Turning to FIGS. 16 and 17, the LED light strip 2 further includes a dielectric layer 2b. The dielectric layer 2b is disposed on a second surface of the wiring layer 2a. The dielectric layer 2b has a different surface area than the wiring layer 2a. The LED light source 202 is disposed on a surface of the wiring layer 2a which is opposite to the other surface of the wiring layer 2a which is adjacent to the dielectric layer 2b. The wiring layer 2a can be a metal layer or a layer having wires such as copper wires.

In an embodiment, the LED light strip 2 further includes a protection layer over the wiring layer 2a and the dielectric layer 2b. The protection layer is made from one of solder resists such as liquid photoimageable.

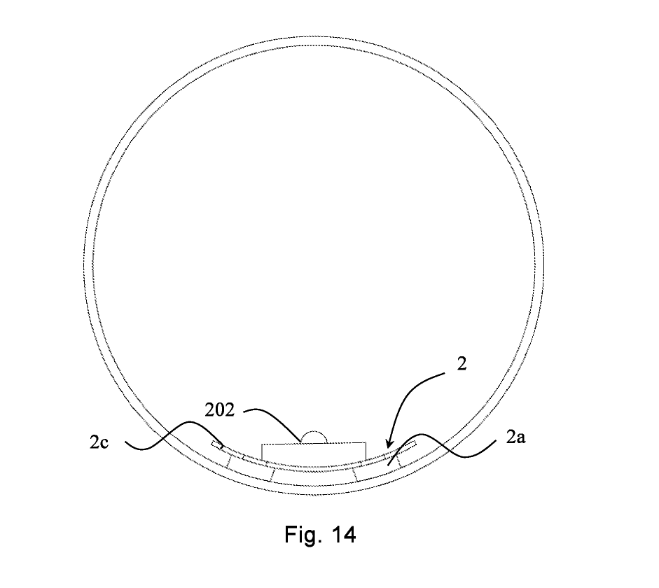

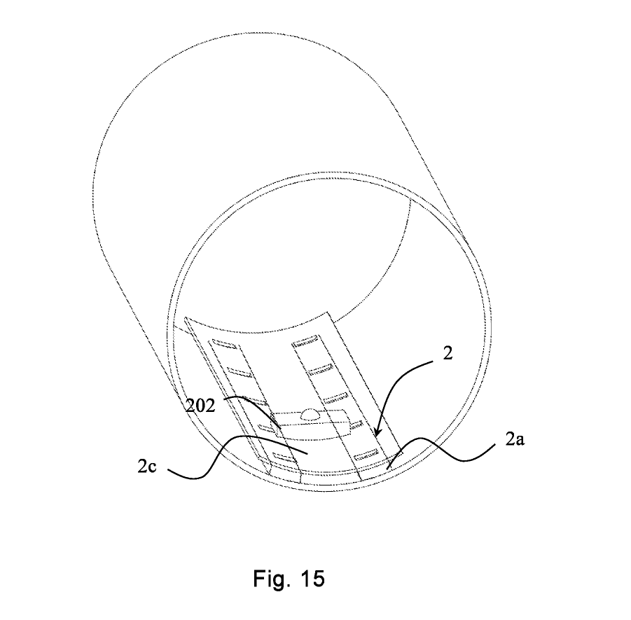

In another embodiment, as shown in FIGS. 14 and 15, the outer surface of the wiring layer 2a or the dielectric layer 2b (i.e. the two layered structure) may be covered with a circuit protective layer 2c made of an ink with function of resisting soldering and increasing reflectivity. Alternatively, the dielectric layer 2b can be omitted and the wiring layer 2a can be directly bonded to the inner circumferential surface of the lamp tube (i.e. the one-layered structure), and the outer surface of the wiring layer 2a is coated with the circuit protective layer 2c. As shown in FIGS. 14 and 15, the circuit protective layer 2c is formed with openings such that the LED light sources 202 are electrically connected to the wiring layer 2a. Whether the one-layered or the two-layered structure is used, the circuit protective layer 2c can be adopted. The bendable circuit sheet is a one-layered structure made of just one wiring layer 2a, or a two-layered structure made of one wiring layer 2a and one dielectric layer 2b, and thus is more bendable or flexible to curl when compared with the conventional three-layered flexible substrate (one dielectric layer sandwiched with two wiring layers). As a result, the bendable circuit sheet of the LED light strip 2 can be installed in a lamp tube with a customized shape or non-tubular shape, and fitly mounted to the inner surface of the lamp tube. The bendable circuit sheet closely mounted to the inner surface of the lamp tube is preferable in some cases. In addition, using fewer layers of the bendable circuit sheet improves the heat dissipation and lowers the material cost.

In some embodiments, any type of power supply 5 can be electrically connected to the LED light strip 2 by means of a traditional wire bonding technique, in which a metal wire has an end connected to the power supply 5 while has the other end connected to the LED light strip 2. Furthermore, the metal wire may be wrapped with an electrically insulating tube to protect a user from being electrically shocked. However, the bonded wires tend to be easily broken during transportation and can therefore cause quality issues.

In still another embodiment, the connection between the power supply 5 and the LED light strip 2 may be accomplished via tin soldering, rivet bonding, or welding. One way to secure the LED light strip 2 is to provide the adhesive sheet at one side thereof and adhere the LED light strip 2 to the inner surface of the lamp tube 1 via the adhesive sheet. Two ends of the LED light strip 2 can be either fixed to or detached from the inner surface of the lamp tube 1.

In case that two ends of the LED light strip 2 are fixed to the inner surface of the lamp tube 1, it may be preferable that the bendable circuit sheet of the LED light strip 2 is provided with the female plug and the power supply is provided with the male plug to accomplish the connection between the LED light strip 2 and the power supply 5. In this case, the male plug of the power supply is inserted into the female plug to establish electrical connection.

In case that two ends of the LED light strip 2 are detached from the inner surface of the lamp tube and that the LED light strip 2 is connected to the power supply 5 via wire-bonding, any movement in subsequent transportation is likely to cause the bonded wires to break. Therefore, a preferable option for the connection between the light strip 2 and the power supply 5 could be soldering. Specifically, the ends of the LED light strip 2 including the bendable circuit sheet are arranged to pass over the strengthened transition region and directly soldering bonded to an output terminal of the power supply 5 such that the product quality is improved without using wires. In this way, the female plug and the male plug, respectively, provided for the LED light strip 2 and the power supply 5 are no longer needed.

Having described at least one of the embodiments of the claimed invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents. Specifically, one or more limitations recited throughout the specification can be combined in any level of details to the extent they are described to improve the LED tube lamp.

What is claimed is:

1. An LED tube lamp, comprising:
a lamp tube, which includes a light transmissive portion, a reinforcing portion and an end cap; and
an LED light assembly, which includes an LED light source and an LED light strip, wherein:
the light transmissive portion is fixedly connected to the reinforcing portion;
the reinforcing portion includes a plurality of bracing structures at endpoints;
the bracing structure includes a combination of a vertical rib and a horizontal rib;
the LED light strip abuts against the bracing structure, which holds the LED light assembly in place;
the LED light source is thermally and electrically connected to the LED light strip;
the end cap is attached to an end of the lamp tube; and
a cross section of the lamp tube defines a hypothetical non-circle curve of constant width.

2. The LED tube lamp in claim 1, wherein the cross section of the lamp tube defines a first hypothetical Reuleaux triangle.

3. The LED tube lamp in claim 2, wherein vertices on the first hypothetical Reuleaux triangle define a hypothetical isosceles triangle.

4. The LED tube lamp in claim 2, wherein a fillet is configured on a vertex on the cross section of the lamp tube.

5. The LED tube lamp in claim 4, wherein a fillet is configured on all vertices on the cross section of the lamp tube.

6. The LED tube lamp in claim 4, wherein the fillet is configured on an interior corner of the vertex on the cross section of the lamp tube.

7. The LED tube lamp in claim 4, wherein a fillet is configured on an exterior corner of the vertex on the cross section of the lamp tube.

8. The LED tube lamp in claim 4, wherein:
a first fillet is configured on an interior corner of the vertex on the cross section of the lamp tube;
a second fillet is configured on an exterior corner of the vertex opposite the interior corner of the vertex on the cross section of the lamp tube; and
the first fillet and the second fillet are spaced apart by a fixed normal distance.

9. The LED tube lamp in claim 8, wherein the fixed normal distance equals a thickness of the lamp tube adjacent to the filleted corner.

10. The LED tube lamp in claim 2, wherein a cross section of the end cap defines a second hypothetical Reuleaux triangle.

11. The LED tube lamp in claim 10, wherein:
the first hypothetical Reuleaux triangle and the second hypothetical Reuleaux triangle are parallel curves; and
the second hypothetical Reuleaux triangle encompasses the first hypothetical Reuleaux triangle.

12. The LED tube lamp in claim 11, wherein a fillet is configured on a vertex on the cross section of the end cap.

13. The LED tube lamp in claim 12, wherein a fillet is configured on all vertices of the cross section of the end cap.

14. The LED tube lamp in claim 12, wherein a fillet is configured on an interior corner of the vertex on the cross section of the end cap.

15. The LED tube lamp in claim 12, wherein a fillet is configured on an exterior corner of the vertex on the cross section of the end cap.

16. The LED tube lamp in claim 2, wherein a bottom edge of a cross section of the reinforcing portion defines a first circular arc on the first hypothetical Reuleaux triangle.

17. The LED tube lamp in claim 16, wherein the bottom edge of the cross section of the reinforcing portion defines a first portion of the first circular arc on the first hypothetical Reuleaux triangle.

18. The LED tube lamp in claim 17, wherein the first portion of the first circular arc on the first hypothetical Reuleaux triangle is a middle portion on the first circular arc on the first hypothetical Reuleaux triangle.

19. The LED tube lamp in claim 18, wherein a cross section of the light transmissive portion defines:
a right portion of the first circular arc on the first hypothetical Reuleaux triangle;
a left portion of the first circular arc on the first hypothetical Reuleaux triangle;
a second circular arc on the first hypothetical Reuleaux triangle; and
a third circular arc on the first hypothetical Reuleaux triangle.

20. The LED tube lamp in claim 19, wherein:
a left vertical rib having a first left base extends upwards from a point S₁ at which the light transmissive portion and the reinforcing portion merge;
a left horizontal rib merges with the left vertical rib at a point slightly higher than an upper surface of the LED light strip;
a right vertical rib having a first right base extends at a point S₂ at which the light transmissive portion and the reinforcing portion merge;
a right horizontal rib merges with the right vertical rib at a point slightly higher than the upper surface of the LED light strip; and
a distance between the first left base and the first right base is slightly greater than a width of the LED light strip.

21. The LED tube lamp in claim 20, wherein:
the left vertical rib leans slightly inwards towards a left edge of the LED light strip; and
the right vertical rib leans slightly inwards towards a right edge of the LED light strip.

22. The LED tube lamp in claim 21, wherein:
the left horizontal rib angles slightly downwards towards the upper surface of the LED light strip; and
the right horizontal rib angles slightly downwards towards the upper surface of the LED light strip.

23. The LED tube lamp in claim 22, wherein:
a left protruding part having a second left base erects from a point closer to S₁ than S₂ between S₁ and S₂ on the reinforcing portion towards a lower surface of the LED light strip;
a right protruding part having a second right base erects from a point closer to S₂ than S₁ between S₁ and S₂ on the reinforcing portion towards the lower surface of the LED light strip; and
friction arising from interfaces among a surface of the LED light strip, the bracing structure and the protruding part holds the LED light assembly in place unless otherwise overcome by a lateral force upon the LED light strip.

24. The LED tube lamp in claim 23, wherein the LED light assembly is removable from the lamp tube by the lateral force without being damaged.

25. The LED tube lamp in claim 23, wherein:
a distance from the first left base to the second left base is identical to a distance from the first right base to the second right base; and
the distance from the first left base to the second left base is less than a distance from the second left base to the second right base.

26. An LED tube lamp, comprising:
a lamp tube, which includes a light transmissive portion, a reinforcing portion and an end cap; and
an LED light assembly, which includes an LED light source and an LED light strip, wherein:
the light transmissive portion is fixedly connected to the reinforcing portion;
the reinforcing portion includes a plurality of bracing structures at endpoints and a plurality of protruding parts spaced apart between the endpoints;
the bracing structure includes a combination of a vertical rib and a horizontal rib;
the LED light strip abuts against the bracing structure, which holds the LED light assembly in place;
the LED light source is thermally and electrically connected to the LED light strip, which is in turn connected to the reinforcing portion;
the end cap is attached to an end of the lamp tube; and
a cross section of the lamp tube defines a hypothetical non-circle curve constructed by three hypothetical circles intersecting one another.

27. The LED tube lamp in claim 26, wherein the cross section of the lamp tube defines a first hypothetical circular triangle.

28. The LED tube lamp in claim 27, wherein the first hypothetical circular triangle has a trio of convex arc edges.

29. The LED tube lamp in claim 27, wherein the first hypothetical circular triangle has a pair of convex arc edges and a concave arc edge.

30. The LED tube lamp in claim 28, wherein vertices on the first circular triangle define a first hypothetical isosceles triangle including a base and a pair of legs.

31. The LED tube lamp in claim 30, wherein a fillet is configured on a vertex on the cross section of the lamp tube.

32. The LED tube lamp in claim 31, wherein a fillet is configured on all vertices on the cross section of the lamp tube.

33. The LED tube lamp in claim 31, wherein a fillet is configured on an interior corner of the vertex on the cross section of the lamp tube.

34. The LED tube lamp in claim 31, wherein a fillet is configured on an exterior corner of the vertex on the cross section of the lamp tube.

35. The LED tube lamp in claim 31, wherein:
a first fillet is configured on an interior corner of the vertex on the cross section of the lamp tube;
a second fillet is configured on an exterior corner on the vertex opposite the interior corner of the vertex on the cross section of the lamp tube; and
the first fillet and the second fillet are spaced apart by a fixed normal distance.

36. The LED tube lamp in claim 35, wherein the fixed normal distance equals a thickness of the lamp tube adjacent to the filleted corner.

37. The LED tube lamp in claim 30, wherein:
a cross section of the end cap defines a second hypothetical circular triangle;
the second hypothetical circular triangle has a trio of convex arc edges; and
vertices on the second hypothetical circular triangle define a second hypothetical isosceles triangle.

38. The LED tube lamp in claim 37, wherein a fillet is configured on a vertex on the cross section of the end cap.

39. The LED tube lamp in claim 38, wherein a fillet is configured on all vertices on the cross section of the end cap.

40. The LED tube lamp in claim 38, wherein a fillet is configured on an interior corner of the vertex on the cross section of the end cap.

41. The LED tube lamp in claim 38, wherein a fillet is configured on an exterior corner of the vertex on the cross section of the end cap.

42. The LED tube lamp in claim 37, wherein:
the first hypothetical isosceles triangle and the second hypothetical isosceles triangle are parallel curves; and
the second hypothetical isosceles triangle encompasses the first hypothetical isosceles triangle.

43. The LED tube lamp in claim 30, wherein a bottom edge of a cross section of the reinforcing portion defines the base on the first hypothetical isosceles triangle.

44. The LED tube lamp in claim 43, wherein the bottom edge of the cross section of the reinforcing portion defines a first portion of the base on the first hypothetical isosceles triangle.

45. The LED tube lamp in claim 44, wherein the first portion of the base on the first hypothetical isosceles triangle is a middle portion on the base on the first hypothetical isosceles triangle.

46. The LED tube lamp in claim 45, wherein a cross section of the light transmissive portion defines:
a right portion of the base on the first hypothetical isosceles triangle;
a left portion of the base on the first hypothetical isosceles triangle; and
the pair of legs on the first hypothetical isosceles triangle.

47. The LED tube lamp in claim 30, wherein the leg of length a is greater than the base of length b.

48. The LED tube lamp in claim 28, wherein the first hypothetical circular triangle having a vertex defines an axis of reflectional symmetry passing through the vertex.

49. The LED tube lamp in claim 30, wherein:
a cross section of an upper surface of the LED light strip defines a hypothetical line; and
the hypothetical line meets the perpendicular bisector of the first hypothetical isosceles triangle at a right angle.

50. The LED tube lamp in claim 49, wherein:
a perpendicular bisector of a hypothetical curve defined by the cross section of the lamp tube is divided by the hypothetical curve defined by the cross section of an inner surface of the lamp tube and the hypothetical line defined by the cross section of the upper surface of the LED light strip into an upper segment of length c and a lower segment of length d; and
the upper segment of length c is greater than the lower segment of length d.

51. The LED tube lamp in claim 49, wherein:
a perpendicular bisector of a hypothetical curve defined by the cross section of the lamp tube is divided by the hypothetical curve defined by the cross section of an inner surface of the lamp tube and the hypothetical line defined by the cross section of the upper surface of the LED light strip into an upper segment of length c and a lower segment of length d; and
the upper segment of length c is less than the lower segment of length d.

52. The LED tube lamp in claim 30, wherein the hypothetical line defined by the cross section of the LED light strip coincides with the base on the first hypothetical isosceles triangle.

53. The LED tube lamp in claim 30, wherein the hypothetical line defined by the cross section of the LED light strip rises above the base on the first hypothetical isosceles triangle.

54. The LED tube lamp in claim 49, wherein the hypothetical line defined by the cross section of the LED light strip sits below the base of the first hypothetical isosceles triangle.

55. The LED tube lamp in claim 30, wherein:
a plane figure defined by the first circular triangle and the pair of legs on the first hypothetical isosceles triangle has an area g;
a plane figure defined by the first circular triangle and the base on the first hypothetical isosceles triangle has an area h; and
g to is greater than 2h.

56. An LED tube lamp, comprising:
a lamp tube, which includes a light transmissive portion, a reinforcing portion and an end cap; and
an LED light assembly, which includes an LED light source and an LED light strip, wherein:
the light transmissive portion is fixedly connected to the reinforcing portion;
the reinforcing portion includes a plurality of bracing structures at endpoints of the reinforcing portion;
the bracing structure includes a combination of a vertical rib and a horizontal rib;
the LED light strip abuts against the bracing structure, which holds the LED light assembly in place;
the LED light source is thermally and electrically connected to the LED light strip;
the end cap is attached to an end of the lamp tube;
a cross section of the lamp tube defines a non-circle hypothetical curve constructed by three hypothetical circles intersecting one another;
the cross section of the lamp tube defines a first hypothetical circular triangle;
the first hypothetical circular triangle has a trio of convex arc edges;
vertices on the first circular triangle define a first hypothetical isosceles triangle including a base and a pair of legs;
a first fillet is configured on an interior corner of a vertex on the cross section of the lamp tube;
a second fillet is configured on an exterior corner of the vertex on the cross section of the lamp tube;
the first fillet and the second fillet are spaced apart by a first fixed normal distance;
the first fixed normal distance equals a thickness of the lamp tube adjacent to the filleted corner;
a cross section of the end cap defines a second hypothetical circular triangle;
the second hypothetical circular triangle has a trio of convex arc edges;
vertices on the second hypothetical circular triangle define a second hypothetical isosceles triangle;
a third fillet is configured on an interior corner of a vertex on the cross section of the end cap;
a fourth fillet is configured on an exterior corner of the vertex on the cross section of the end cap;
the third fillet and the fourth fillet are spaced apart by a second fixed normal distance;
the second fixed normal distance equals a thickness of the end cap adjacent to the filleted corner;
the first hypothetical isosceles triangle and the second hypothetical isosceles triangle are parallel curves;
the second hypothetical isosceles triangle encompasses the first hypothetical isosceles triangle;
a bottom edge of a cross section of the reinforcing portion defines a first portion of the base on the first hypothetical isosceles triangle;
the first portion of the base on the first hypothetical isosceles triangle is a middle portion on the base on the first hypothetical isosceles triangle; and
a cross section of the light transmissive portion defines a right portion of the base on the first hypothetical isosceles triangle; a left portion of the base on the first hypothetical isosceles triangle; and the pair of legs on the first hypothetical isosceles triangle.

57. The LED tube lamp in claim 56, wherein the thickness of the lamp tube is the same as the thickness of the end cap.
